(19) United States
(12) Patent Application Publication
(10) Pub. No.: US 2024/0039853 A1
(43) Pub. Date: Feb. 1, 2024

(54) COMMUNICATION DEVICE, COMMUNICATION SWITCH, AND ITAS PERIOD SETTING METHOD

(71) Applicant: Fujitsu Limited, Kawasaki-shi (JP)

(72) Inventors: Norikazu HIKIMOCHI, Kanazawa (JP); Kazuto NISHIMURA, Yokohama (JP); Shoji MIYAKE, Yokohama (JP); Jiro TAKEZAWA, Kawasaki (JP); Yoshikazu SABETTO, Fukuoka (JP)

(73) Assignee: Fujitsu Limited, Kawasaki-shi (JP)

(21) Appl. No.: 18/327,504

(22) Filed: Jun. 1, 2023

(30) Foreign Application Priority Data
Jul. 27, 2022 (JP) 2022-119863

(51) Int. Cl. H04L 47/22; H04L 45/24; H04L 47/2425

(52) U.S. Cl. CPC H04L 47/225; H04L 45/245; H04L 47/2433

(57) ABSTRACT

A communication device to be coupled to a transmission device with MC-LAG, the communication device includes a first output port coupled to an other communication device within a first route, a second output port within a second route, an iTAS device arranged in each of the first output port and the second output port, and configured to preferentially output a high priority flow, based on a set an iTAS period, a memory, and a processor coupled to the memory and configured to acquire a first iTAS period set to the iTAS device arranged in the first output port and a second iTAS period set to an iTAS device arranged in a third output port in the other communication device within the first route, and set an iTAS period of the iTAS device arranged in the second output port, based on the first and second iTAS periods.

### CROSS-REFERENCE TO RELATED APPLICATION

This application is based upon and claims the benefit of priority of the prior Japanese Patent Application No. 2022-119863, filed on Jul. 27, 2022, the entire contents of which are incorporated herein by reference.

### FIELD

The embodiment discussed herein is related to a communication device, a communication switch, and an iTAS period setting method.

### BACKGROUND

In recent years, in order to realize a fifth generation mobile communication system (5G), for example, a centralized radio access network (C-RAN) including a baseband unit (BBU), a remote radio head (RRH), a centralized unit (CU), a distributed unit (DU), and a radio unit (RU) has been considered. For a mobile front haul (MFH) link between the DU and the RU, adoption of an enhanced common public radio interface (eCPRI) method for storing a radio signal in an Ether Frame and transmitting the radio signal has been considered.

In a communication system coupled to the MFH link, information is treated as layer 2 packets. Therefore, the communication system can share a network with a mobile back haul (MBH) link for coupling between base stations, a wired network, or the like. However, in the communication system, an output delay of an MFH packet from the MFH link occurs due to a timing conflict with another packet flow, for example, an MBH flow from the MBH link. Therefore, priority control processing for preventing the output delay has been known. In the priority control processing, since a subsequent high priority flow overtakes a queued low priority flow and is preferentially read, the output delay of the high priority flow, for example, the MFH flow can be prevented.

Furthermore, as another method for preventing the output delay of the MFH flow, an institute of electrical and electronics engineers (IEEE) 802.1 time sensitive networking (TSN) has been considered. As the TSN, as a data plane function for preventing the output delay of the MFH flow, a time aware shaper (TAS) method called IEEE802.1Qbv is known.

A TAS device that adopts the TAS technology switches each gate, based on a gate control list (GCL) used to control switching of the gate provided for each type of reception flow. Each gate includes a gate that switches an output of the MFH flow and a gate that switches an output of the MBH flow. The GCL manages switching information used to control switching of each gate for each time slot (TS), using a traffic pattern of the MFH flow. The TAS device can preferentially output the MFH flow, by controlling switching of each gate for each TS with reference to the GCL.

Furthermore, for the TAS device, in order to realize very sensitive gate switching setting of the order of microseconds, a mechanism for maintaining the setting is required. Therefore, the TAS device acquires timings of the MFH flow and the MBH flow and autonomously learns a transfer period, a phase, or the like of these packet flows. Then, the TAS device adopts an intelligent TAS (iTAS) technology for collecting content of a GCL table used to manage an output timing of the MFH flow or the MFH flow, based on the autonomously learned content.

FIG. 24 is a flowchart illustrating an example of a processing operation of each iTAS device related to iTAS processing. In FIG. 24, the iTAS device executes a period determination phase (step S101). The iTAS device that executes the period determination phase samples a burst signal of the MFH flow so as to repeatedly detect a periodicity of the burst signal of the MFH flow. Then, the iTAS device adjusts a list length of the GCL, based on the periodicity of the burst signal of the MFH flow that has been repeatedly detected.

Moreover, after executing the period determination phase, the iTAS device executes a closed TS determination phase (step S102). The iTAS device that executes the closed TS determination phase detects a traffic pattern (burst length, position, or the like) of the burst signal of the MFH flow. Then, the iTAS device determines a closed TS used to stop an output of a non-MFH flow at the output timing of the MFH flow and generates the GCL.

Then, after executing the closed TS determination phase, the iTAS device executes a stationary monitoring phase in which an operation is started (step S103). The iTAS device that executes the stationary monitoring phase executes a switching operation of an output gate of each packet flow, based on the GCL. Note that, in the stationary monitoring phase, there is a possibility that a time of learning differs from a packet arrival timing due to a clock deviation or the like. Therefore, the closed TS in the GCL is corrected while monitoring the difference. As a result, the output delay of the high priority flow can be prevented.

Furthermore, in recent years, as a technology for extending link aggregation (LAG), multi-chassis link aggregation (MC-LAG) has been known. The MC-LAG is a technology for extending the LAG between adjacent communication devices and constructing the LAG by logically making the plurality of communication devices appear as a single communication device. The MC-LAG has an ACT/STBY redundant configuration, for example, setting a communication device that operates one of two paths to be in an active (ACT) state and another communication device that uses another path as a spare to be in a standby (STBY) state.

FIG. 25 is an explanatory diagram illustrating an example of a packet switch 100 of the MC-LAG. The packet switch 100 illustrated in FIG. 25 includes a first network element (NE) 101A that is a communication device included in the MC-LAG, a second NE 101B that is a communication device included in the MC-LAG, and a third NE 120. The third NE 120 is a transmission device that couples the first NE 101A and the second NE 101B in the MC-LAG method. Each of the first NE 101A and the second NE 101B includes a forwarding database (FDB) that manages a combination between a destination MAC address, an output port, and a VLAN, refers to the FDB, and outputs a received packet to a transfer destination port.

Furthermore, an inter peer link (IPL) 113 couples between the first NE 101A and the second NE 101B. The IPL 113 is a dedicated link used to execute FDB synchronization between the first NE 101A and the second NE 101B.

The first NE 101A includes an L2SW-side port 111 that is coupled to an external L2SW, an MC-LAG-side port 112 that is coupled to the third NE 120, and an IPL-side port that is coupled to the second NE 101B. The L2SW-side port 111 in the first NE 101A includes an L2SW output port 111A that outputs a packet flow to the L2SW. The MC-LAG-side port 112 in the first NE 101A includes an MC-LAG output port 112A that outputs a packet flow to the third NE 120. The IPL-side port in the first NE 101A includes an IPL output port 113A that outputs a packet flow to the second NE 101B.

The second NE 101B includes the L2SW-side port 111 that is coupled to an external L2SW, the MC-LAG-side port 112 that is coupled to the third NE 120, and the IPL-side port that is coupled to the second NE 101B. The L2SW-side port 111 in the second NE 101B includes an L2SW output port 111B that outputs a packet flow to the L2SW. The MC-LAG-side port 112 in the second NE 101B includes an MC-LAG-side output port 112B that outputs a packet flow to the third NE 120. The IPL-side port in the second NE 101B includes an IPL output port 113B that outputs a packet flow to the first NE 101A.

The third NE 120 includes an L2SW-side port 122 that is coupled to an external L2SW and a LAG-side port 121 that is coupled to the first NE 101A and is coupled to the second NE 101B. The LAG-side port 121 in the third NE 120 includes a LAG output port 121A that outputs a packet flow to the first NE 101A and a LAG output port 121B that outputs a packet flow to the second NE 101B.

In a case where the first NE 101A is in the ACT state and the second NE 101B is in the STBY state, the third NE 120 realizes communication of the packet flow using a path to the first NE 101A in the ACT state. Moreover, in a case where a failure occurs in the path between the first NE 101A and the third NE 120, the first NE 101A is in the STBY state and the second NE 101B is in the ACT state. As a result, the third NE 120 realizes the communication of the packet flow using a path to the second NE 101B. As a result, the MC-LAG can secure communication reliability.

Japanese Laid-open Patent Publication No. 2017-183873 and Japanese Laid-open Patent Publication No. 2020-77994 are disclosed as related art.

### SUMMARY

According to an aspect of the embodiments, a communication device to be coupled to a transmission device with multi-chassis link aggregation (MC-LAG), the communication device includes a first output port coupled to an other communication device, the first output port being included within a first route, a second output port within a second route, an intelligent time aware shaper (iTAS) device arranged in each of the first output port and the second output port, and configured to preferentially output a high priority flow, based on a set an iTAS period, a memory, and a processor coupled to the memory and configured to acquire a first iTAS period set to the iTAS device arranged in the first output port and a second iTAS period set to an iTAS device arranged in a third output port in the other communication device, the third output port being included within the first route, and set an iTAS period of the iTAS device arranged in the second output port, based on the first iTAS period and the second iTAS period.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a communication system;

FIG. 2 is an explanatory diagram illustrating an example of a configuration of a packet switch;

FIG. 3 is an explanatory diagram illustrating an example of a hardware configuration of a NE;

FIG. 4 is an explanatory diagram illustrating an example of a configuration of an iTAS device;

FIG. 5 is an explanatory diagram illustrating an example of a functional configuration of a first NE and a second NE;

FIG. 6 is an explanatory diagram illustrating an example of a flow of a high priority flow from an L2SW to a third NE in the first NE in an ACT state;

FIG. 7 is an explanatory diagram illustrating an example of a flow of a high priority flow from the L2SW to the third NE in the second NE in the ACT state;

FIG. 8 is an explanatory diagram illustrating an example of a flow of a high priority flow from the third NE to the L2SW in the first NE in the ACT state;

FIG. 9 is an explanatory diagram illustrating an example of a flow of a high priority flow from the third NE to the L2SW in the second NE in the ACT state;

FIG. 10 is an explanatory diagram illustrating an example of features for each iTAS type;

FIG. 11 is an explanatory diagram illustrating a reason for setting to a least common multiple of an iTAS period;

FIG. 12 is a flowchart illustrating an example of a processing operation of the first NE and the second NE related to iTAS period fixing processing;

FIG. 13 is a flowchart illustrating an example of a processing operation of the first NE and the second NE related to period determination processing;

FIG. 14 is an explanatory diagram related to the processing for determining a period of the high priority flow flowing from the L2SW by the first NE and the second NE;

FIG. 15 is an explanatory diagram related to the processing for determining the period of the high priority flow flowing from the third NE, by the first NE;

FIG. 16 is a flowchart illustrating an example of a processing operation of the first NE and the second NE related to period information synchronization processing;

FIG. 17 is an explanatory diagram illustrating an example of a processing operation of the first NE and the second NE related to period information synchronization processing when MFH periods of the high priority flows flowing from the L2SWs are synchronized;

FIG. 18 is an explanatory diagram illustrating an example of a processing operation of the first NE and the second NE related to period information synchronization processing when MFH periods of the high priority flows flowing from the third NE are synchronized;

FIG. 19 is an explanatory diagram illustrating an example of a processing operation of the first NE and the second NE related to IPL-side port period fixing processing;

FIG. 20 is an explanatory diagram illustrating an example of a processing operation of the first NE and the second NE related to IPL period information synchronization processing;

FIG. 21 is an explanatory diagram illustrating an example of a processing operation of the first NE and the second NE related to L2SW-side port period fixing processing;

FIG. 22 is an explanatory diagram illustrating an example of a processing operation of the first NE and the second NE related to MC-LAG-side port period fixing processing;

FIG. 23 is an explanatory diagram illustrating an example of a processing operation of the first NE and the second NE related to a stationary monitoring phase;

FIG. 24 is a flowchart illustrating an example of a processing operation of each iTAS device related to iTAS processing;

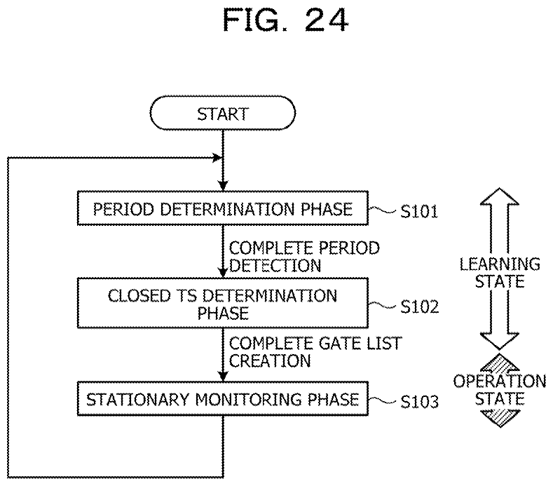

FIG. 25 is an explanatory diagram illustrating an example of a packet switch of an MC-LAG;

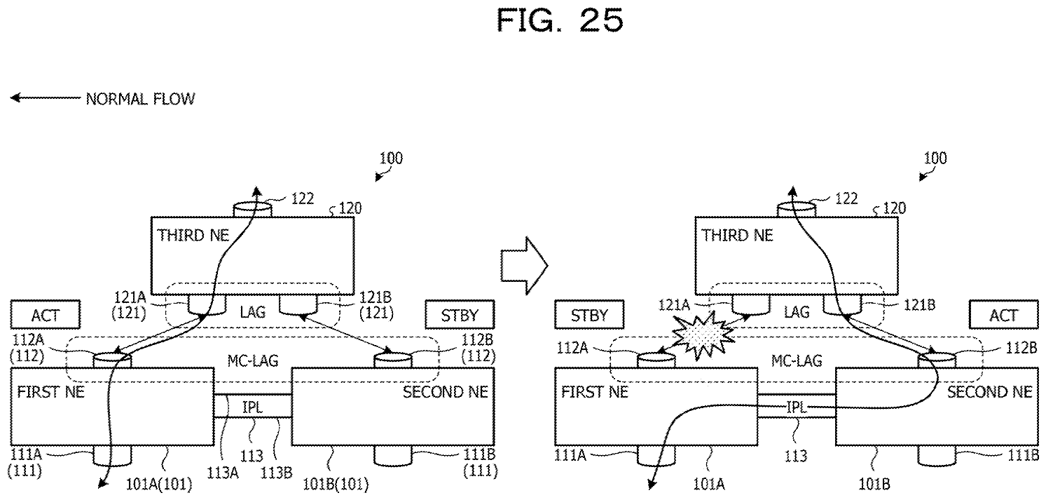

FIG. 26 is an explanatory diagram illustrating an example of a processing operation of a first NE in an ACT state in a packet switch according to a comparative example; and

FIG. 27 is an explanatory diagram illustrating an example of a processing operation at the time of a path failure between the first NE and a third NE in the packet switch according to the comparative example.

### DESCRIPTION OF EMBODIMENTS

For a packet switch of a typical MC-LAG, it is required to adopt an iTAS device that prevents an output delay of a high priority flow for each port in a communication device (NE) in the MC-LAG for securing communication reliability.

### COMPARATIVE EXAMPLE

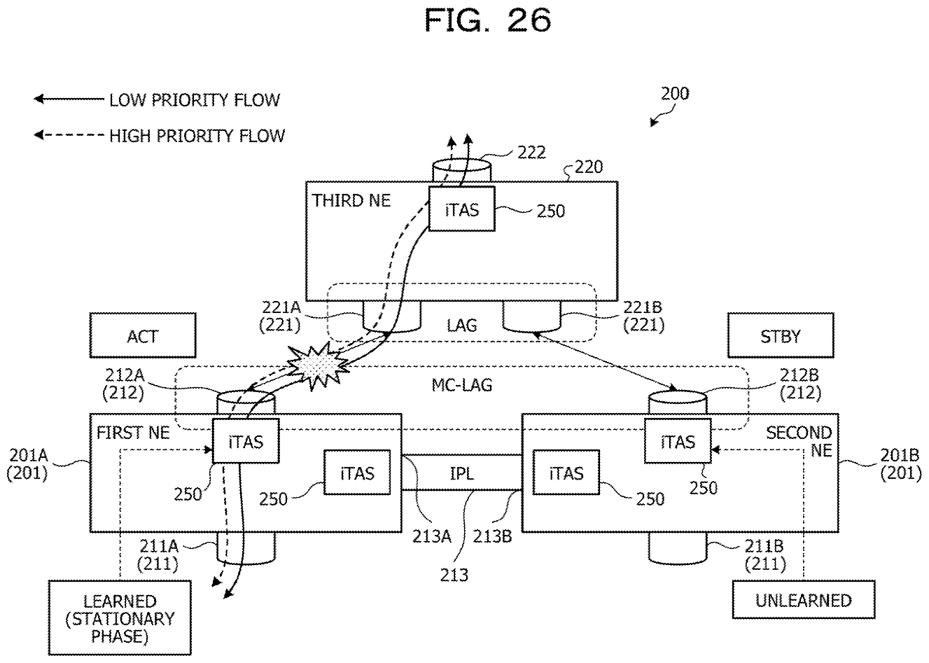

FIG. 26 is an explanatory diagram illustrating an example of a processing operation of a first NE 201A in an ACT state in a packet switch 200 according to a comparative example. The packet switch 200 illustrated in FIG. 26 includes the first NE 201A (201) included in an MC-LAG, a second NE 201B (201) included in the MC-LAG, a third NE 220. The third NE 220 couples the first NE 201A and the second NE 201B in an MC-LAG method. Each of the first NE 201A and the second NE 201B includes an FDB that manages a combination of a destination MAC address, an output port, and a VLAN, refers to the FDB, and outputs a received packet to a transfer destination port.

Furthermore, an IPL 213 couples between the first NE 201A and the second NE 201B. The IPL 213 is a dedicated link used to execute FDB synchronization between the first NE 201A and the second NE 201B.

The first NE 201A includes an L2SW-side port 211 that is coupled to an external L2SW, an MC-LAG-side port 212 that is coupled to the third NE 220, and an IPL-side port that is coupled to the second NE 201B. The first NE 201A includes an iTAS device 250 for each port. The L2SW-side port 211 in the first NE 201A includes an L2SW output port 211A that outputs a packet flow to the L2SW. The MC-LAG-side port 212 in the first NE 201A includes an MC-LAG output port 212A that outputs a packet flow to the third NE 220. The IPL-side port in the first NE 201A includes an IPL output port 213A that outputs a packet flow to the second NE 201B. The first NE 201A includes, for example, the iTAS device 250 arranged in the L2SW output port 211A, the iTAS device 250 arranged in the MC-LAG output port 212A, and the iTAS device 250 arranged in the IPL output port 213A.

The second NE 201B includes the L2SW-side port 211 is coupled to the external L2SW, the MC-LAG-side port 212 is coupled to the third NE 220, and the IPL-side port is coupled to the first NE 201A. The second NE 201B includes the iTAS device 250 for each port. The L2SW-side port 211 in the second NE 201B includes an L2SW output port 211B that outputs a packet flow to the L2SW. The MC-LAG-side port 212 in the second NE 201B includes an MC-LAG output port 212B that outputs a packet flow to the third NE 220. The IPL-side port in the second NE 201B includes an IPL output port 213B that outputs a packet flow to the second NE 201B. The second NE 201B includes, for example, the iTAS device 250 arranged in the L2SW output port 211B, the iTAS device 250 arranged in the MC-LAG output port 212B, and the iTAS device 250 arranged in the IPL output port 213B.

The third NE 220 includes an L2SW-side port 222 that is coupled to the external L2SW and a LAG-side port 221 that is coupled to the first NE 201A and the second NE 201B. The LAG-side port 221 in the third NE 220 includes a LAG output port 221A that outputs a packet flow to the first NE 201A and a LAG output port 221B that outputs a packet flow to the second NE 201B. The L2SW-side port 222 is an output port that outputs a packet flow to the L2SW. The third NE 220 includes the iTAS device 250 for each port. The third NE 220 includes, for example, the iTAS device 250 arranged in the LAG output port 221A, the iTAS device 250 arranged in the LAG output port 221B, and the iTAS device 250 arranged in the L2SW-side port 222.

The iTAS device 250 monitors an arrival packet of the high priority flow with the single packet switch 200, specifies a periodicity of the arrival packet, and predicts an arrival timing of the arrival packet. At the arrival timing of the high priority flow, by stopping an output of a low priority flow and avoiding a collision delay between the high priority flow and the low priority flow, the high priority flow is preferentially output.

It is assumed that, when the first NE 201A is in the ACT state and the second NE 201B is in the STBY state, the iTAS device 250 in the first NE 201A receive the high priority flow from the L2SW via the L2SW output port 211A, for example. The iTAS device 250 in the first NE 201A refers to the learned GCL, and outputs the high priority flow from the MC-LAG output port 212A to the third NE 220 in a case where switching information of the high priority flow corresponding to a current TS number is open. At this time, the first NE 201A continues a stationary monitoring phase while learning content of the GCL. On the other hand, since the second NE 201B is in the STBY state, the content of the GCL is unlearned.

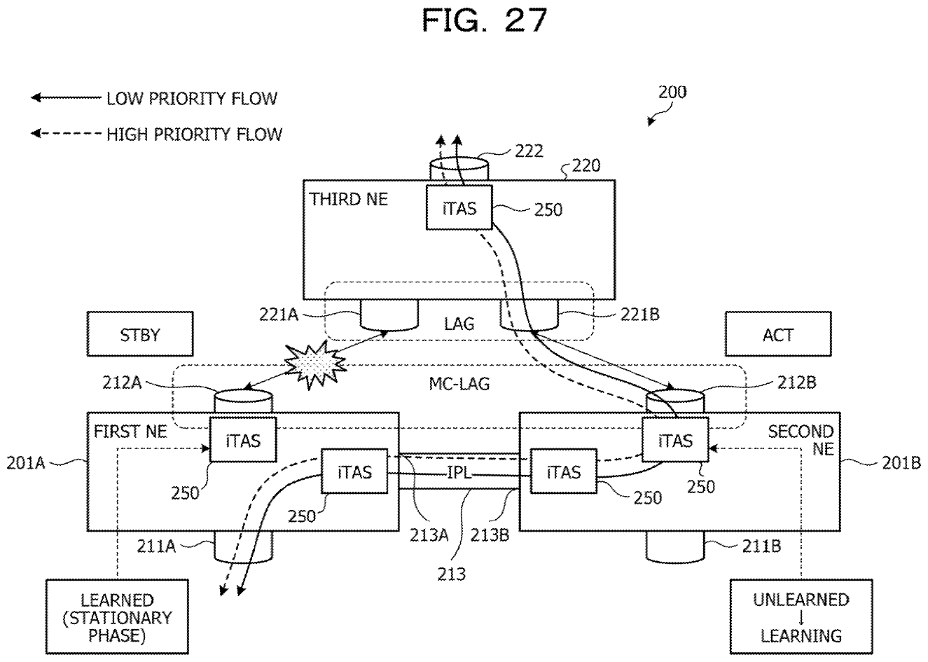

FIG. 27 is an explanatory diagram illustrating an example of a processing operation at the time of a path failure between the first NE 201A and the third NE 220 in the packet switch 200 according to the comparative example. In a case where a failure occurs in the path to the third NE 220, the first NE 201A switches the state of the first NE 201A to the STBY state and the state of the second NE 201B to the ACT state. Then, a path between the second NE 201B and the third NE 220 turns to be in the ACT state. Then, in a case of receiving the high priority flow via the L2SW output port 211A, the iTAS device 250 in the first NE 201A outputs the high priority flow to the second NE 201B from the IPL output port 213A of the IPL 13.

Moreover, in a case of receiving the high priority flow from the first NE 201A via the IPL 213, the iTAS device 250 in the second NE 201B outputs the high priority flow to the third NE 220 via the MC-LAG output port 212B. Therefore, the iTAS device 250 in the second NE 201B autonomously learns switching information of the high priority flow for each TS number in the GCL, based on the periodicity of the received high priority flow, when switching from the STBY state to the ACT state. Therefore, in a case where the STBY state is switched to the ACT state, since the content of the GCL is unlearned, the second NE 201B executes a period determination phase for learning the content of the GCL and a closed TS determination phase. However, since the second NE 201B takes time before a transition to the stationary monitoring phase, communication for preferentially outputting the high priority flow is interrupted, and an output delay of the high priority flow occurs.

For the packet switch 200 of the MC-LAG, a system is required that can prevent the output delay of the high priority flow without interrupting communication even in a case where a path in an active state is switched from the path to the first NE 201A to the path to the second NE 201B.

Therefore, an embodiment of the packet switch of the MC-LAG that can continue communication even in a case where paths to the NEs 210 are switched between in the MC-LAG incorporating the iTAS device will be described below as an embodiment.

### EMBODIMENTS

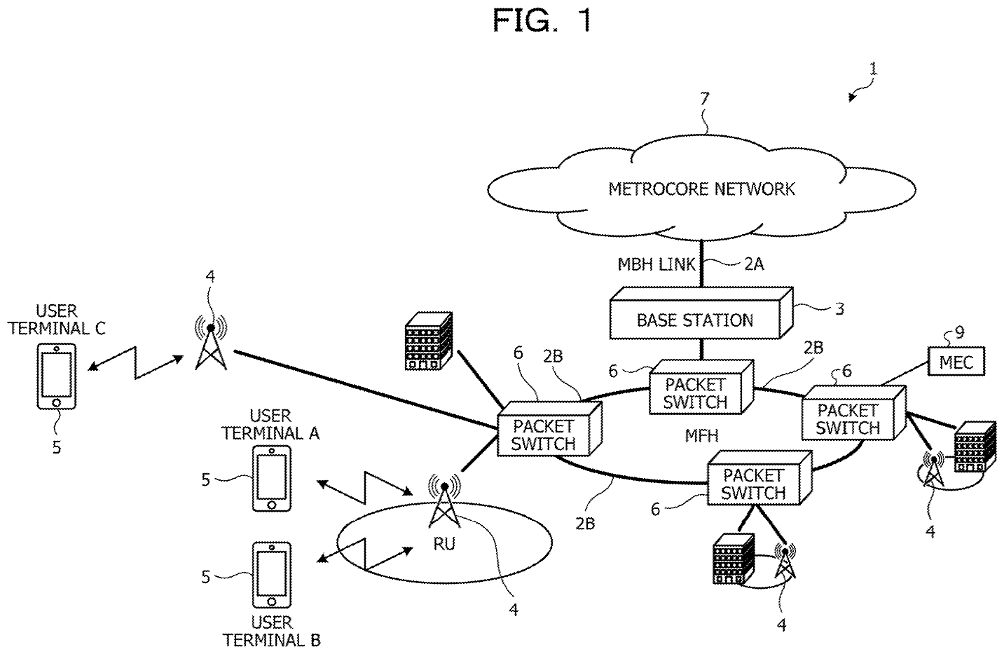

FIG. 1 is an explanatory diagram illustrating an example of a communication system 1. The communication system 1 illustrated in FIG. 1 includes an MBH link 2A, an MFH link 2B, a base station 3, an RU 4, a user terminal 5, a packet switch 6, and a multi-access edge computing (MEC) 9. The MBH link 2A is a link that couples between the plurality of base stations (evolved node B: eNB) 3 or between the base station 3 and a metrocore network 7. The MFH link 2B is, for example, a link that couples between the RU 4 and a DU in the base station 3. The RU 4 is wirelessly coupled to the user terminal 5. The MFH link 2B adopts an eCPRI method for transmitting a radio signal between the RU 4 and the DU using an L2-frame MFH flow. The packet switch 6 transmits various packet flows such as an MBH flow from the MBH link 2A, an MFH flow from the MFH link 2B, or the like. For the MFH flow, prevention of an output delay is more strongly required as compared with the MBH flow.

The DU has a scheduling function in a wireless section. The scheduling function is a function to determine various elements, for example, user data, a code rate, a modulation scheme, or the like to be transmitted to one sub-frame. The DU divides the user data into L2 frames and transmits an MFH packet to the RU 4. For example, the DU transmits the MFH flow to the RU 4 at sub-frame intervals, for example, every one msec. Furthermore, the RU 4 divides user data of the received radio signal into the L2 frames and transmits the MFH flow to the DU. The MEC 9 is an edge server considering an access from the user terminal 5, for example, a local 5G terminal, a Wi-Fi device, an IoT device, or the like.

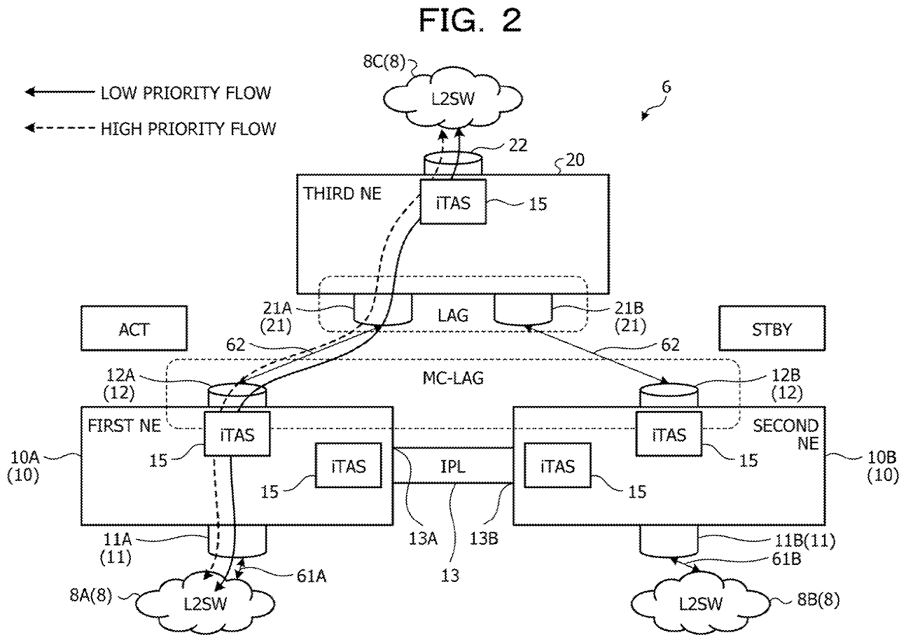

FIG. 2 is an explanatory diagram illustrating an example of a configuration in the packet switch 6. The packet switch 6 is a communication switch that includes a first NE 10A that is a communication device included in the MC-LAG, a second NE 10B that is a communication device included in the MC-LAG, and a third NE 20. The third NE 20 is a transmission device that is coupled to the first NE 10A and the second NE 10B in an MC-LAG method. Each of the first NE 10A and the second NE 10B includes an FDB that manages a combination of a destination MAC address, an output port, and a VLAN, refers to the FDB, and outputs a received packet flow to a transfer destination port.

Furthermore, an IPL 13 couples between the first NE 10A and the second NE 10B. The IPL 13 is a third path that is a dedicated link used to execute FDB synchronization between the first NE 10A and the second NE 10B. The first NE 10A and the second NE 10B communicate with each other using the IPL 13 and can autonomously recognize that the own device is in an ACT state or a STBY state, for example, according to whether or not a failure occurs.

The first NE 10A includes an L2SW-side port 11 that is coupled to an L2SW 8 using a first path 61A, an MC-LAG-side port 12 that is coupled to the third NE 20 using a second path 62, and an IPL-side port that is coupled to the second NE 10B using the IPL 13. The L2SW-side port 11 in the first NE 10A includes an L2SW output port 11A that is coupled to the first path 61A and outputs a packet flow to an L2SW 8A. The MC-LAG-side port 12 in the first NE 10A includes an MC-LAG output port 12A that is coupled to the second path 62 and outputs a packet flow to the third NE 20. The IPL-side port in the first NE 10A includes an IPL output port 13A that is coupled to the IPL 13 and outputs a packet flow to the second NE 10B. The first NE 10A includes an iTAS device 15 for each port. The first NE 10A includes, for example, the iTAS device 15 arranged in the L2SW output port 11A, the iTAS device 15 arranged in the MC-LAG output port 12A, and the iTAS device 15 arranged in the IPL output port 13A.

The second NE 10B includes the L2SW-side port 11 that is coupled to the L2SW 8 using a fourth path 61B, the MC-LAG-side port 12 that is coupled to the third NE 20 using the second path 62, and the IPL-side port that is coupled to the first NE 10A using the IPL 13. The L2SW-side port 11 in the second NE 10B includes an L2SW output port 11B that is coupled to the fourth path 61B and outputs a packet flow to an L2SW 8B. The MC-LAG-side port 12 in the second NE 10B includes an MC-LAG output port 12B that is coupled to the second path 62 and outputs a packet flow to the third NE 20. The IPL-side port in the second NE 10B includes an IPL output port 13B that is coupled to the IPL 13 and outputs a packet flow to the first NE 10A. The second NE 10B includes the iTAS device 15 for each port. The second NE 10B includes, for example, the iTAS device 15 arranged in the L2SW output port 11B, the iTAS device 15 arranged in the MC-LAG output port 12B, and the iTAS device 15 arranged in the IPL output port 13B.

The third NE 20 includes an L2SW-side port 22 that is coupled to an external L2SW 8C (8) and a LAG-side port 21 that is coupled to the first NE 10A and the second NE 10B. The LAG-side port 21 in the third NE 20 includes a LAG output port 21A that outputs a packet flow to the first NE 10A using the second path 62 and a LAG output port 21B that outputs a packet flow to the second NE 10B using the second path 62. The third NE 20 includes the iTAS device 15 for each port. The third NE 20 includes, for example, the iTAS device 15 arranged in the LAG output port 21A, the iTAS device 15 arranged in the LAG output port 21B, and the iTAS device 15 arranged in the L2SW-side port 22.

The iTAS device 15 monitors an arrival packet of a high priority flow with the single packet switch 6, specifies a periodicity of the arrival packet, and predicts an arrival timing of the arrival packet. At the arrival timing of the high priority flow, by stopping an output of a low priority flow and avoiding a collision delay between the high priority flow and the low priority flow, the high priority flow is preferentially output.

When the first NE 10A is in the ACT state and the second NE 10B is in the STBY state, the iTAS device 15 in the first NE 10A receives the high priority flow from the L2SW 8 via the L2SW output port 11A or the IPL output port 13B, for example. The iTAS device 15 in the first NE 10A refers to the learned GCL, and outputs the high priority flow from the MC-LAG output port 12A to the third NE 20 in a case where switching information of the high priority flow corresponding to a current TS number is open. At this time, the iTAS device 15 in the first NE 10A continues a stationary monitoring phase while learning content of the GCL.

When the first NE 10A is in the STBY state and the second NE 10B is in the ACT state, the iTAS device 15 in the second NE 10B receives the high priority flow from the L2SW 8 via the L2SW output port 11B or the IPL output port 13A, for example. The iTAS device 15 in the second NE 10B refers to the learned GCL, and outputs the high priority flow from the MC-LAG output port 12B to the third NE 20 in a case where the switching information of the high priority flow corresponding to the current TS number is open. At this time, the iTAS device 15 in the second NE 10B continues the stationary monitoring phase while learning the content of the GCL.

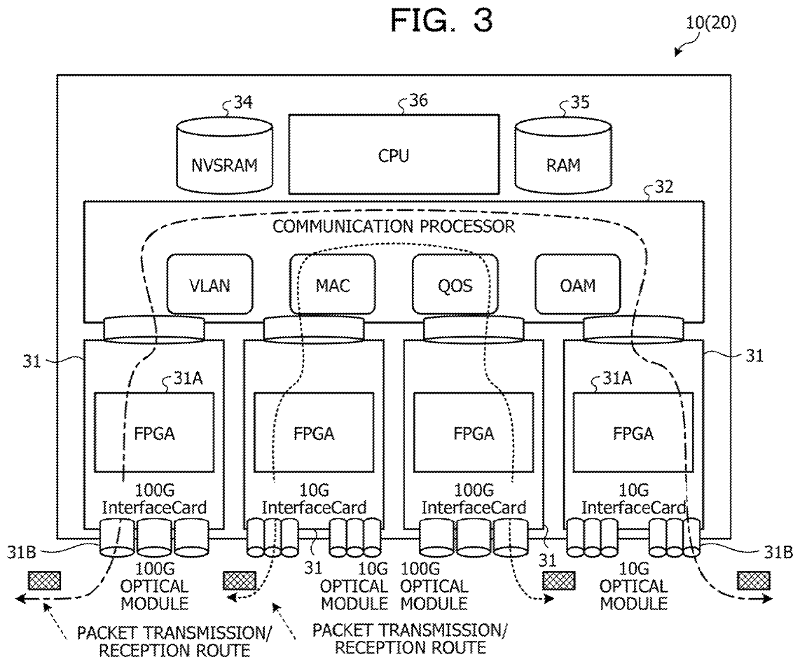

FIG. 3 is an explanatory diagram illustrating an example of a hardware configuration of the NE 10 (20). Note that the NE 10 (20) is, for example, the first NE 10A, the second NE 10B, or the third NE 20. The NE 10 (20) illustrated in FIG. 3 includes an interface (IF) card 31, a communication processor 32, a central processing unit 36, a non-volatile RAM (NVSRAM) 34, and a random access memory (RAM) 35. The IF card 31 includes a field programmable gate array (FPGA) 31A and a plurality of ports 31B. The IF card 31 is a communication card corresponding to a line speed. The FPGA 31A controls, for example, the entire IF card 31 such as light ON/OFF or module Power ON/OFF. The FPGA 31A incorporates the iTAS device 15 for each port 31B.

For example, in a case where the NE 10 is the first NE 10A, the ports 31B include the L2SW-side port 11, the MC-LAG-side port 12, the IPL-side port, or the like. Furthermore, for example, in a case where the NE 10 is the second NE 10B, the ports 31B include the L2SW-side port 11, the MC-LAG-side port 12, the IPL-side port, or the like. Furthermore, for example, in a case where the NE 20 is the third NE 20, the ports 31B include the L2SW-side port 22, the LAG-side port 21, or the like.

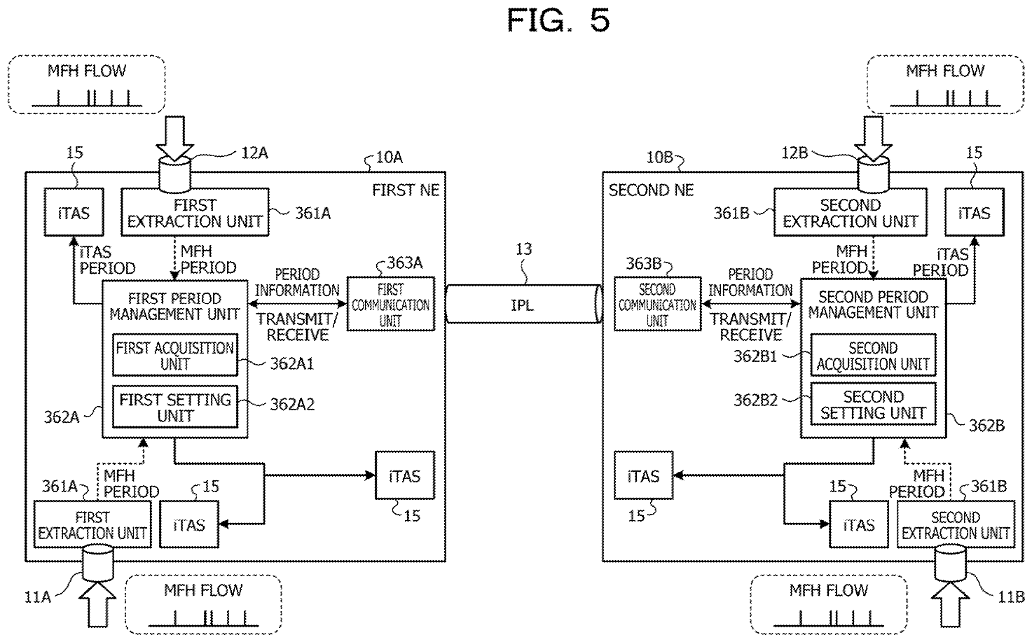

The communication processor 32 is a processor that controls a communication function of an L2 of the packet switch 6 or the like. The communication function of the L2 or the like includes, for example, virtual LAN (VLAN), media access control (MAC), quality of service (QOS), operation administration maintenance (OAM), or the like. The NVSRAM 34 is a nonvolatile memory that holds configuration information or the like of a database or the like. The RAM 35 is a volatile memory that holds, for example, period information managed by a first period management unit 362A (second period management unit 362B) used by software. (Refer to FIG. 5)

The CPU 36 controls the entire NE 10 (20). In a case where the NE 10 is the first NE 10A, the CPU 36 controls the entire first NE 10A. In a case where the NE 10 is the second NE 10B, the CPU 36 controls the entire second NE 10B. In a case where the NE 20 is the third NE 20, the CPU 36 controls the entire third NE 20.

Next, each iTAS device 15 arranged in the FPGA 31A in the NE 10 (20) will be described. The iTAS device 15 transmits various packet flows, in addition to the MBH flow and the MFH flow. The iTAS device 15 applies a time aware shaper (TAS) method of the IEEE802.1Qbv and outputs the MFH flow as a high priority flow.

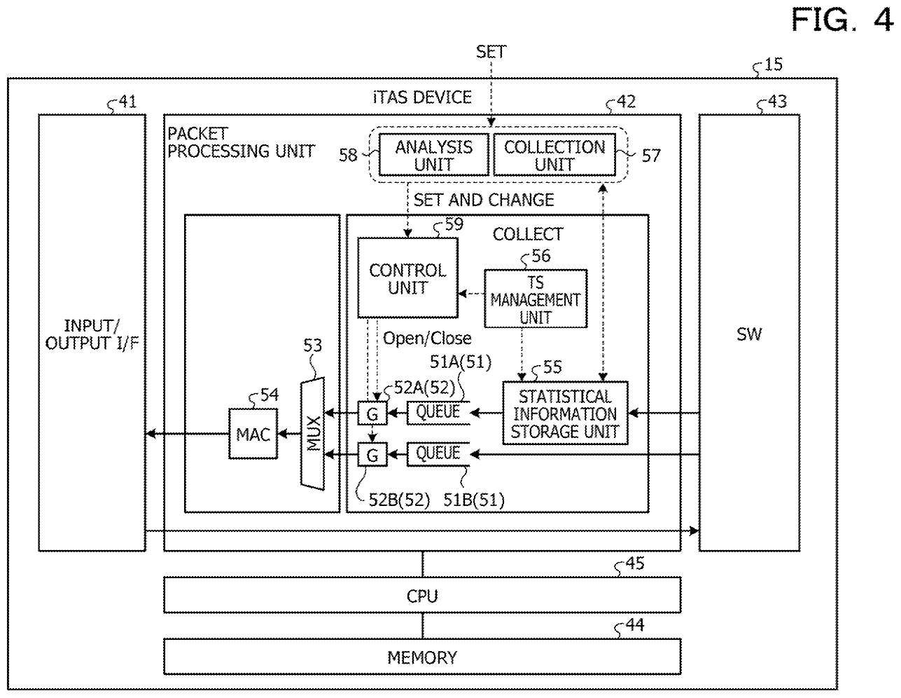

FIG. 4 is an explanatory diagram illustrating an example of a hardware configuration of the iTAS device 15. The iTAS device 15 illustrated in FIG. 4 includes an input/output IF 41, a packet processing unit 42, a switch (SW) 43, a memory 44, and a CPU 45. The input/output IF 41 is an IF that is coupled to various links such as the MBH link 2A or the MFH link 2B and inputs/outputs the packet flow. The input/output IF 41 is coupled to, for example, the RU 4, the DU, and another iTAS devices 15. The packet processing unit 42 executes packet processing to which an iTAS method is applied. The SW 43 is a switch used to switch input/output of the packet processing unit 42. The memory 44 is a region where various types of information is stored. The CPU 45 controls the entire iTAS device 15.

The packet processing unit 42 controls not only output timings of the MBH flow and the MFH flow but also a timing of a priority output of the MFH flow. The packet processing unit 42 includes a plurality of queues 51, a plurality of gates 52, a multiplexer (MUX) 53, a MAC 54, a statistical information storage unit 55, a TS management unit 56, a collection unit 57, an analysis unit 58, and a control unit 59.

Each queue 51 is a storage unit that is included for each type of received packet flow to be arrived and queues the received packet flow for each type. Note that, as the type of the received packet flow, for example, the MFH flow or the MBH flow is included. The MFH flow is a high priority flow, whereas the MBH flow is a low priority flow that has lower priority than the MFH flow.

A first queue 51A of the plurality of queues 51 is a storage unit that queues the MBH flow, from among the received packet flows to be arrived. Furthermore, a second queue 51B of the plurality of queues 51 is a storage unit that queues the MFH flow, from among the received packet flows to be arrived.

The SW 43 identifies a P bit of a VLAN tag in the received packet flow, and transfers a received packet flow of a type to the queue 51 according to the type of the received packet flow, based on the identification result.

Each gate 52 is provided for each queue 51 and switches an output of the received packet flow stored in the queue 51 in TS units. Note that one TS is assumed as, for example, 0.5 μs. Among the plurality of gates 52, a first gate 52A switches an output of the MBH flow in the first queue 51A in TS units. Among the plurality of gates 52, a second gate 52B switches an output of the MFH flow in the second queue 51B in TS units.

The MUX 53 selectively outputs an output packet of each gate 52. The MAC 54 adds a MAC address to the output packet of the MUX 53 and outputs the output packet to which the MAC address has been added to the input/output IF 41. The statistical information storage unit 55 is a region where a periodic pattern of the received packet flow is stored as statistical information. The TS management unit 56 includes a time counter that counts a current counter value in TS units.

The collection unit 57 collects the statistical information of the received packet flow. The statistical information is a received packet amount for each time period. Note that the packet amount is, for example, the number of packets or the number of bytes. The analysis unit 58 analyzes the statistical information of the received packet and specifies a periodicity pattern such as a periodicity or a pattern of the received packet flow. The analysis unit 58 learns an arrival interval (periodicity) and a pattern (average arrival amount and degree of burst fluctuation) of the received packet flow.

FIG. 5 is an explanatory diagram illustrating an example of a functional configuration of the first NE 10A and the second NE 10B. The CPU 36 in the first NE 10A includes a first extraction unit 361A, the first period management unit 362A, and a first communication unit 363A. The first extraction unit 361A extracts an MFH period that is a period of a high priority flow flowing into the iTAS device 15 arranged for each port in the first NE 10A. The first period management unit 362A manages the period information used for the first NE 10A. The first period management unit 362A includes a first acquisition unit 362A1 and a first setting unit 362A2. The first communication unit 363A communicates with a second communication unit 363B in the second NE 10B using the IPL 13.

The first acquisition unit 362A1 acquires the period information used for the first NE 10A. The period information used for the first NE 10A includes a first iTAS period α set to the iTAS device 15 arranged in the IPL output port 13A and a second iTAS period β set to the iTAS device 15 arranged in the IPL output port 13B.

The first setting unit 362A2 sets a third iTAS period θ in which the first iTAS period α and the second iTAS period β do not collide, to the iTAS device 15 arranged in the MC-LAG output port 12A. Note that the third iTAS period θ is, for example, a period, in which the first iTAS period α and the second iTAS period β do not overlap and high priority packet outputs do not conflict, obtained based on a least common multiple period of the first iTAS period α and the second iTAS period β. However, the period is not limited to the period of the least common multiple and may be a period that takes OR (OR) of the first iTAS period α and the second iTAS period β. The first setting unit 362A2 sets the second iTAS period β to the iTAS device 15 arranged in the L2SW output port 11A.

The CPU 36 in the second NE 10B includes a second extraction unit 361B, the second period management unit 362B, and the second communication unit 363B. The second extraction unit 361B extracts an MFH period that is a period of a high priority flow flowing into the iTAS device 15 arranged for each port in the second NE 10B. The second period management unit 362B manages the period information used for the second NE 10B. The second period management unit 362B includes a second acquisition unit 362B1 and a second setting unit 362B2. The second communication unit 363B communicates with the first communication unit 363A in the first NE 10A using the IPL 13.

The second acquisition unit 362B1 acquires the period information used for the second NE 10B. The period information used for the second NE 10B includes the first iTAS period α set to the iTAS device 15 arranged in the IPL output port 13A and the second iTAS period β set to the iTAS device 15 arranged in the IPL output port 13B.

The second setting unit 362B2 sets the third iTAS period θ in which the first iTAS period α and the second iTAS period β do not collide, to the iTAS device 15 arranged in the MC-LAG output port 12B. The second setting unit 362B2 sets the second iTAS period β to the iTAS device 15 arranged in the L2SW output port 11B.

For convenience of description, it is assumed that the first NE 10A be in the ACT state and the second NE 10B be in the STBY state. The first extraction unit 361A extracts the MFH period of the MFH flow flowing into each iTAS device 15 provided for each output port in the first NE 10A from each iTAS device 15, and notifies the first period management unit 362A of first period information such as the extracted MFH period. The first period information is information regarding an MFH period B of a first high priority flow flowing from the L2SW-side port 11 of the first NE 10A and an MFH period E of a fifth high priority flow and an MFH period F of a sixth high priority flow that flow from the MC-LAG-side port 12 of the first NE 10A. The first period management unit 362A stores the first period information in the RAM 35.

Moreover, the first communication unit 363A communicates with the second NE 10B via the IPL 13. The first communication unit 363A notifies the second NE 10B of the first period information stored in the RAM 35 via the IPL 13 and receives second period information to be described later, from the second NE 10B via the IPL 13.

In a case of receiving the second period information, the first period management unit 362A stores the second period information in the RAM 35. Then, the first period management unit 362A stores the first period information of each iTAS device 15 on the side of the first NE 10A and the second period information of each iTAS device 15 on the side of the second NE 10B.

The second extraction unit 361B extracts an MFH period of the MFH flow flowing into each iTAS device 15 provided for each output port in the second NE 10B from each iTAS device 15 and notifies the second period management unit 362B of the second period information such as the extracted MFH period. Note that the second period information is information such as an MFH period A of a second high priority flow flowing from the L2SW-side port 11 in the second NE 10B. The second period management unit 362B stores the second period information in the RAM 35.

Moreover, the second communication unit 363B notifies the first NE 10A of the second period information stored in the RAM 35 via the IPL 13 and receives the first period information from the first NE 10A via the IPL 13.

In a case of receiving the first period information, the second period management unit 362B stores the first period information in the RAM 35. Then, the second period management unit 362B stores the second period information of each iTAS device 15 on the side of the second NE 10B that is the own device and the first period information of each iTAS device 15 on the side of the first NE 10A that is a counterpart device.

The first acquisition unit 362A1 in the first period management unit 362A calculates the first iTAS period α of the iTAS device 15 arranged in the IPL output port 13A, based on the MFH periods B and E of the MFH periods A, B, E, and F that are the first period information and the second period information. Then, the first setting unit 362A2 in the first period management unit 362A sets the calculated first iTAS period α to the iTAS device 15 arranged in the IPL output port 13A.

Moreover, the first period management unit 362A stores the calculated first iTAS period α in the RAM 35. Moreover, the first communication unit 363A notifies the second NE 10B of the first iTAS period α, via the IPL 13. Then, the second period management unit 362B stores the received first iTAS period α in the RAM 35.

Furthermore, the second acquisition unit 362B1 in the second period management unit 362B calculates the second iTAS period β of the iTAS device 15 arranged in the IPL output port 13B, based on the MFH periods A and F of the MFH periods A, B, E, and F that are the first period information and the second period information. Then, the second setting unit 362B2 in the second period management unit 362B sets the calculated second iTAS period β to the iTAS device 15 arranged in the IPL output port 13B.

Moreover, the second period management unit 362B stores the calculated second iTAS period β in the RAM 35. Moreover, the second communication unit 363B notifies the first NE 10A of the second iTAS period β, via the IPL 13. Then, the first period management unit 362A stores the received second iTAS period 3 in the RAM 35.

The first setting unit 362A2 sets the second iTAS period β stored in the RAM 35 to the iTAS device arranged in the L2SW output port 11A. Moreover, the first acquisition unit 362A1 calculates the third iTAS period θ of the iTAS device 15 arranged in the MC-LAG output port 12A in the first NE 10A, based on the iTAS periods α and β stored in the RAM 35. Then, the first setting unit 362A2 sets the calculated third iTAS period θ to the iTAS device 15 arranged in the MC-LAG output port 12A in the first NE 10A.

Furthermore, the second setting unit 362B2 sets the first iTAS period α stored in the RAM 35 as the iTAS period arranged in the L2SW output port 11B. Moreover, the second acquisition unit 362B1 calculates the third iTAS period θ of the iTAS device 15 arranged in the MC-LAG output port 12B in the second NE 10B, based on the iTAS periods α and β stored in the RAM 35. Then, the second setting unit 362B2 sets the calculated third iTAS period θ to the iTAS device 15 arranged in the MC-LAG output port 12B in the second NE 10B.

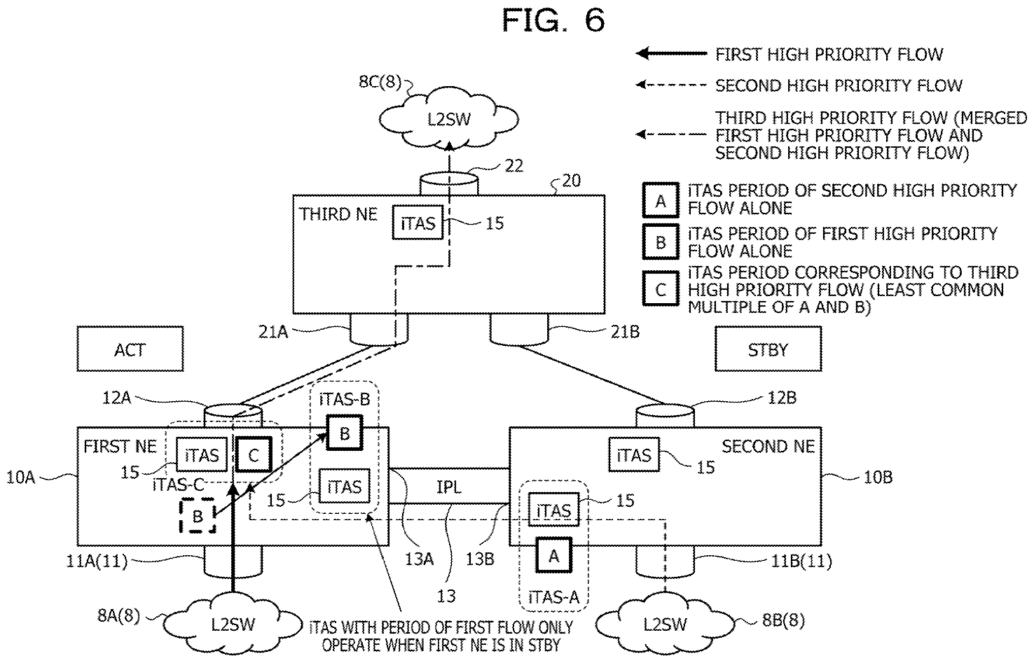

Next, concept of the iTAS period of each iTAS device 15 of the first NE 10A and the second NE 10B will be described. FIG. 6 is an explanatory diagram illustrating an example of a flow of a high priority flow from the L2SW 8 to the third NE 20 in the first NE 10A in the ACT state. It is assumed that the first NE 10A be in the ACT state and the second NE 10B be in the STBY state. Then, the MFH period of the first high priority flow flowing from the L2SW-side port 11 in the first NE 10A into the third NE 20 is set to B, and the MFH period of the second high priority flow flowing from the L2SW-side port 11 in the second NE 10B into the third NE 20 via the IPL 13 is set to A. In this case, since the first high priority flow and the second high priority flow merge, the iTAS period in the iTAS device 15 arranged in the MC-LAG output port 12A is an iTAS period in which the MFH period B of the first high priority flow and the MFH period A of the second high priority flow do not collide. The iTAS period in the iTAS device 15 arranged in the MC-LAG output port 12A is, for example, an iTAS period C obtained based on a least common multiple of the iTAS period A and the iTAS period B. Note that the iTAS period of the iTAS device 15 arranged in the IPL output port 13A of the IPL 13 in the first NE 10A is assumed as B.

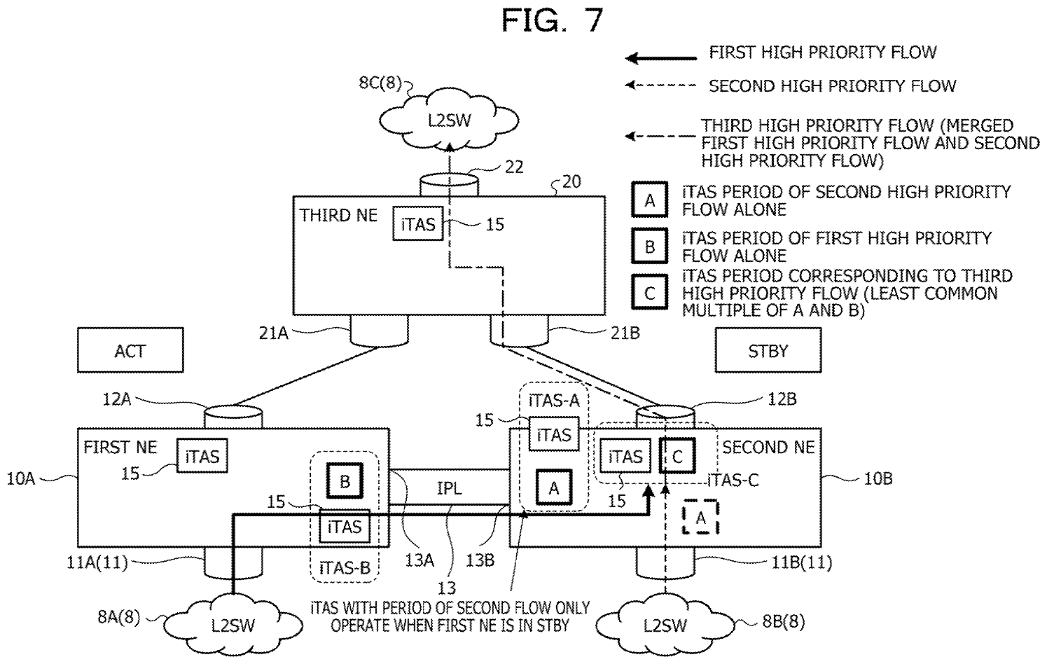

FIG. 7 is an explanatory diagram illustrating an example of a flow of the high priority flow from the L2SW 8 to the third NE 20 in the second NE 10B in the ACT state. It is assumed that the second NE 10B be in the ACT state and the first NE 10A be in the STBY state. Then, the MFH period of the second high priority flow flowing from the L2SW-side port 11 in the second NE 10B into the third NE 20 is set to A, and the MFH period of the first high priority flow flowing from the L2SW-side port 11 in the first NE 10A into the third NE 20 via the IPL 13 is set to B. In this case, since the first high priority flow and the second high priority flow merge, the iTAS period of the iTAS device 15 arranged in the MC-LAG output port 12B is an iTAS period in which an iTAS period B of a first flow and an iTAS period A of a second flow do not collide. The iTAS period in the iTAS device 15 arranged in the MC-LAG output port 12B is, for example, an iTAS period C obtained based on a least common multiple of the iTAS period A and the iTAS period B. Note that the iTAS period of the iTAS device 15 arranged in the IPL output port 13B of the IPL 13 of the second NE 10B is set to A.

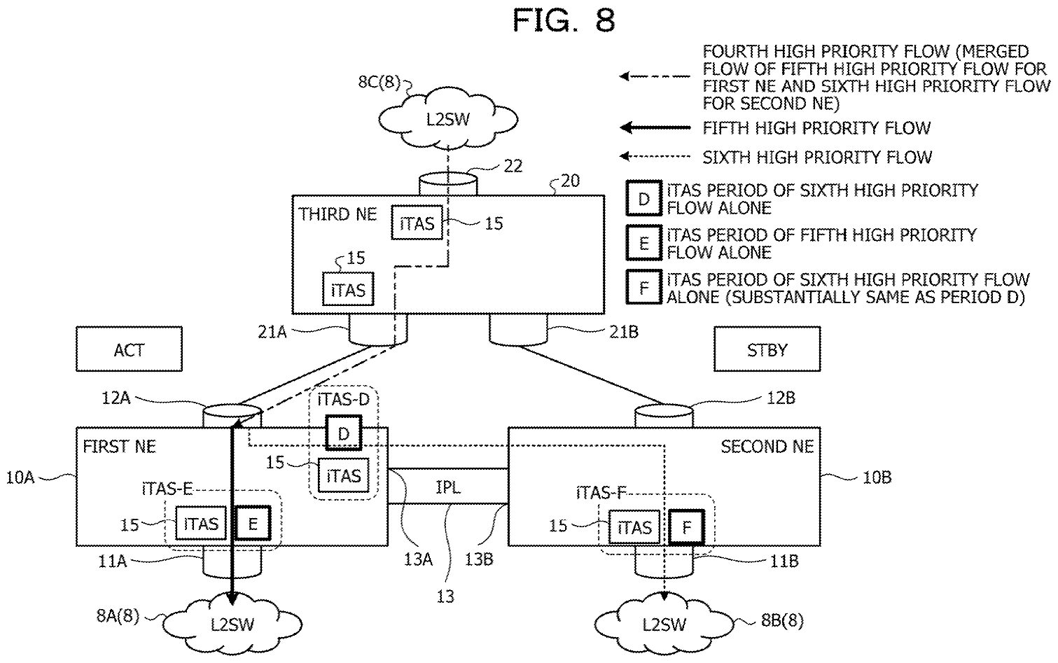

FIG. 8 is an explanatory diagram illustrating an example of a flow of a high priority flow from the third NE 20 into the L2SW 8 in the first NE 10A in the ACT state. It is assumed that the first NE 10A be in the ACT state and the second NE 10B be in the STBY state. The MFH period of the fifth high priority flow flowing from the LAG output port 21A of the third NE 20 into the L2SW 8A is set to E, the MFH period of the sixth high priority flow flowing from the LAG output port 21A in the third NE 20 into the L2SW 8B via the first NE 10A and the IPL 13 is set to D. Moreover, the fifth high priority flow and the sixth high priority flow flowing from the LAG output port 21A in the third NE 20 into the MC-LAG-side port 12 in the first NE 10A are included in the fourth high priority flow. In this case, the iTAS period of the iTAS device 15 arranged in the L2SW output port 11A in the first NE 10A is the MFH period E of the fifth high priority flow. The iTAS period of the iTAS device 15 arranged in the IPL output port 13A in the first NE 10A is the MFH period D of the sixth high priority flow. Moreover, the iTAS period of the iTAS device 15 arranged in the L2SW output port 11B in the second NE 10B is set to the MFH period F that is substantially the same as the MFH period D of the sixth high priority flow.

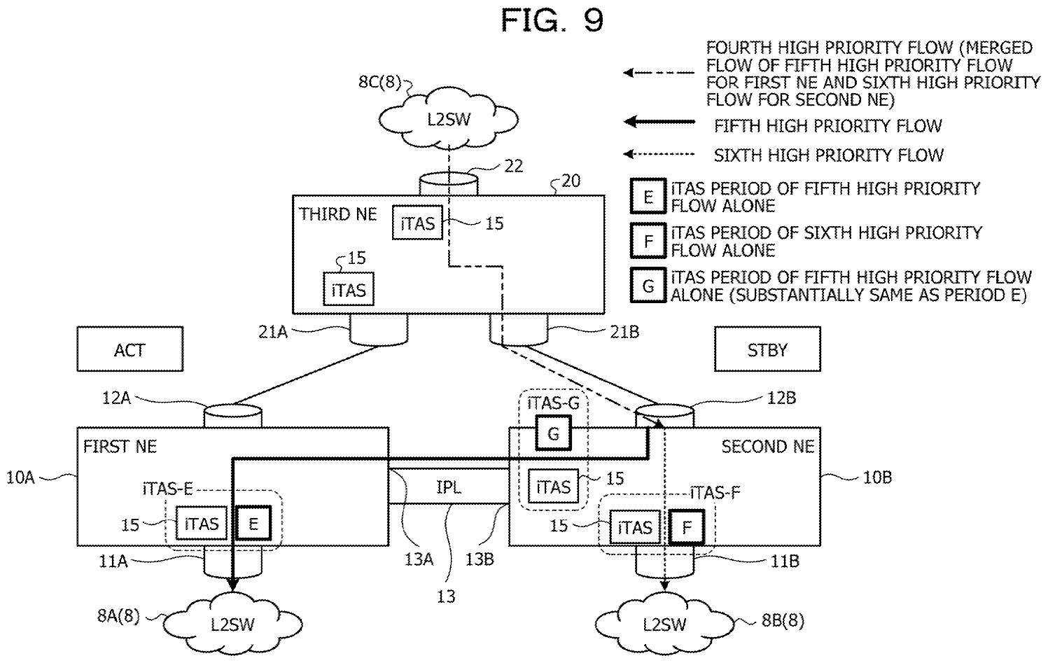

FIG. 9 is an explanatory diagram illustrating an example of a flow of the high priority flow from the third NE 20 into the L2SW 8 in the second NE 10B in the ACT state. It is assumed that the second NE 10B be in the ACT state and the first NE 10A be in the STBY state. Then, the MFH period of the fifth high priority flow flowing from the LAG output port 21B in the third NE 20 into the L2SW 8A is set to E, and the MFH period of the sixth high priority flow flowing from the LAG output port 21A in the third NE 20 into the L2SW 8B is set to F. Moreover, the fifth high priority flow and the sixth high priority flow flowing from the LAG output port 21A in the third NE 20 into the MC-LAG-side port 12 in the second NE 10B are included in the fourth high priority flow. In this case, the iTAS period of the iTAS device 15 arranged in the IPL output port 13B in the second NE 10B is the MFH period G of the fifth high priority flow. Moreover, the iTAS period of the iTAS device 15 arranged in the L2SW output port 11A in the first NE 10A is the MFH period F of the sixth high priority flow. Moreover, the iTAS period of the iTAS device 15 arranged in the L2SW output port 11A in the first NE 10A is set to the MFH period G that is substantially the same as the MFH period E of the fifth high priority flow.

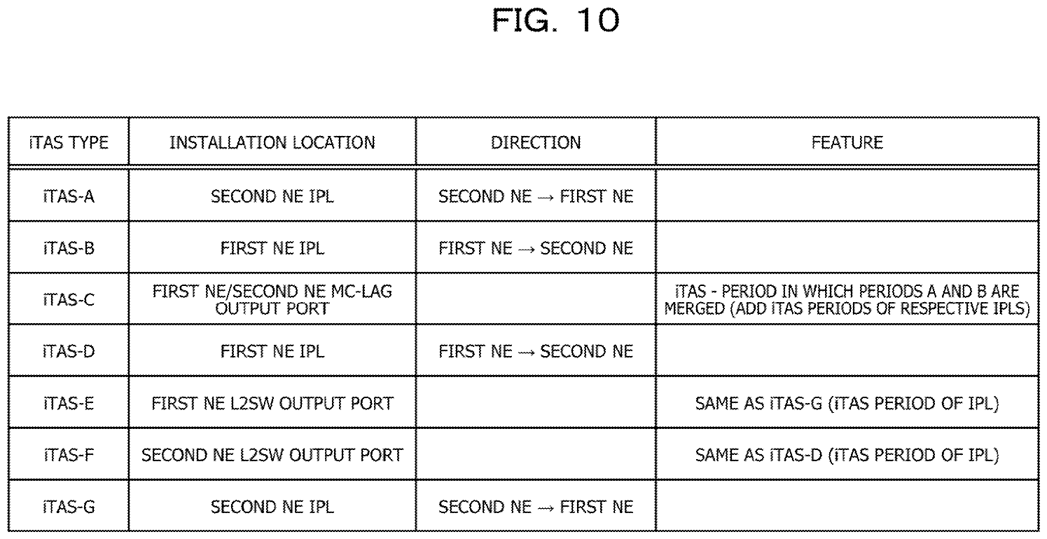

FIG. 10 is an explanatory diagram illustrating an example of features for each iTAS type. As illustrated in FIG. 6, an iTAS type iTAS-A is the iTAS period of the iTAS device 15 arranged in the IPL output port 13B of the IPL 13 in the second NE 10B. The iTAS type iTAS-A is the MFH period A of the second high priority flow flowing from the second NE 10B into the first NE 10A. As illustrated in FIG. 6, an iTAS type iTAS-B is the iTAS period of the iTAS device 15 arranged in the IPL output port 13A of the IPL 13 in the first NE 10A. The iTAS type iTAS-B is the MFH period B of the first high priority flow flowing from the first NE 10A into the second NE 10B via the IPL 13.

As illustrated in FIG. 6, an iTAS type iTAS-C is the iTAS period of the iTAS device 15 arranged in the MC-LAG output port 12A in the first NE 10A. The iTAS type iTAS-C is the MFH period C of the third high priority flow flowing from the first NE 10A into the third NE 20. The iTAS type iTAS-C is the least common multiple of the iTAS type iTAS-A and the iTAS type iTAS-B. Furthermore, as illustrated in FIG. 7, the iTAS type iTAS-C is the iTAS period of the iTAS device 15 arranged in the MC-LAG output port 12B in the second NE 10B. The iTAS type iTAS-C is the MFH period C of the third high priority flow flowing from the second NE 10B into the third NE 20. The iTAS type iTAS-C is the least common multiple of the iTAS type iTAS-A and the iTAS type iTAS-B.

As illustrated in FIG. 7, an iTAS type iTAS-D is the iTAS period of the iTAS device 15 arranged in the IPL output port 13A in the first NE 10A. The iTAS type iTAS-D is the MFH period of the high priority flow flowing from the first NE 10A into the second NE 10B via the IPL 13.

As illustrated in FIG. 7, an iTAS type iTAS-G is the iTAS period of the iTAS device 15 arranged in the IPL output port 13B in the second NE 10B. The iTAS type iTAS-G is the MFH period of the high priority flow flowing from the second NE 10B into the first NE 10A via the IPL 13.

As illustrated in FIG. 8, an iTAS type iTAS-E is the iTAS period of the iTAS device 15 arranged in the L2SW output port 11A in the first NE 10A. The iTAS type iTAS-E is the MFH period of the high priority flow flowing from the first NE 10A into the L2SW 8A. At this time, the iTAS type iTAS-E is an iTAS period that is the same as the iTAS type iTAS-G.

As illustrated in FIG. 9, an iTAS type iTAS-F is the iTAS period of the iTAS device 15 arranged in the L2SW output port 11B in the second NE 10B. The iTAS type iTAS-F is the MFH period of the high priority flow flowing from the second NE 10B into the L2SW 8B. At this time, the iTAS type iTAS-F is an iTAS period that is the same as the iTAS type iTAS-D.

The iTAS period of the iTAS device 15 arranged in the IPL output port 13A is the first iTAS period α that is the least common multiple of the MFH period B and the MFH period E. The iTAS period of the iTAS device 15 arranged in the IPL output port 13B is the second iTAS period β that is the least common multiple of the MFH period A and the MFH period F.

The iTAS period of the iTAS device 15 arranged in the L2SW output port 11A is the second iTAS period β of the iTAS device 15 arranged in the IPL output port 13B. The iTAS period of the iTAS device 15 arranged in the L2SW output port 11B is the first iTAS period α of the iTAS device 15 arranged in the IPL output port 13A.

The iTAS period of the iTAS device 15 arranged in the MC-LAG output ports 12A and 12B is the least common multiple of the first iTAS period α and the second iTAS period 3.

The first period management unit 362A in the first NE 10A in the ACT state calculates the iTAS periods of the iTAS devices 15 arranged in the MC-LAG output port 12A and the L2SW output port 11A in the first NE 10A, based on the first iTAS period α and the second iTAS period 3. The second period management unit 362B in the second NE 10B in the STBY state also calculates the iTAS periods of the iTAS devices 15 arranged in the MC-LAG output port 12B and the L2SW output port 11B in the second NE 10B, based on the first iTAS period α and the second iTAS period 3. As a result, even in a case where path switching of the MC-LAG occurs, relearning is unnecessary, and the output delay of the high priority flow can be quickly prevented.

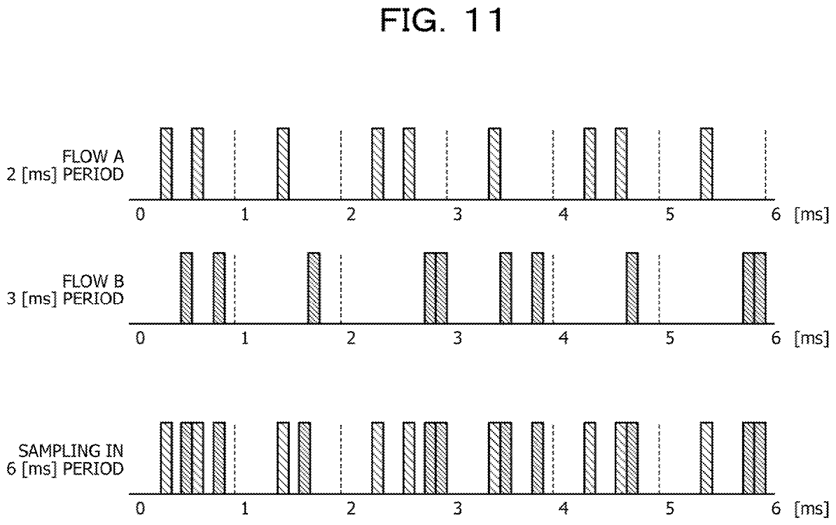

The least common multiple of the iTAS period will be described. FIG. 11 is an explanatory diagram illustrating a reason for setting to the least common multiple of the iTAS period. The first high priority flow is assumed as a high priority flow in which the same waveform appears for each MFH period, for example, every two msec. Furthermore, the second high priority flow is assumed as a high priority flow in which the same waveform appears for each MFH period, for example, three msec. At this time, in the iTAS device 15 at a point where the first high priority flow and the second high priority flow merge, it is needed to set the iTAS period so that the MFH periods do not collide so as to prevent the collision of the first high priority flow and the second high priority flow. Therefore, the period in which the MFH periods do not collide can be easily calculated based on the least common multiple of different MFH periods. Therefore, the iTAS period of the iTAS device 15 at the merging point is a six-msec period that is the least common multiple of two msec and three msec. Then, the iTAS device 15 where the first high priority flow and the second high priority flow merge sets the calculated six-msec period to the GCL as the iTAS period. Then, the iTAS device 15 can preferentially output the high priority flow without collision between the first high priority flow and the second high priority flow, by controlling the gate based on the content of the GCL.

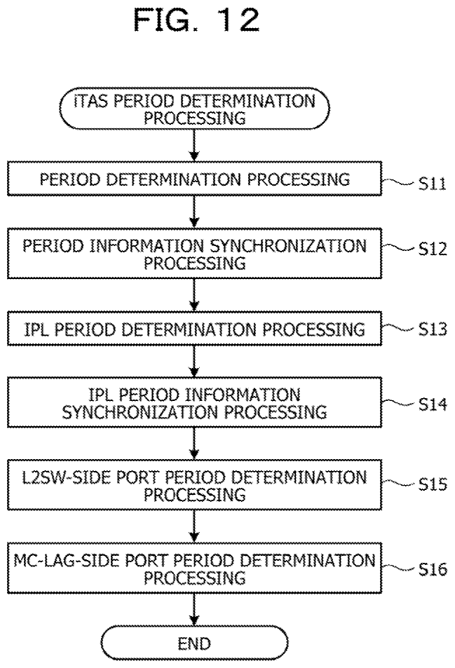

FIG. 12 is a flowchart illustrating an example of a processing operation of the first NE 10A and the second NE 10B related to iTAS period fixing processing. The iTAS period fixing processing is processing executed by the CPUs 36 in the first NE 10A and the second NE 10B in the packet switch 6 according to a predetermined timing during operation. Note that, for convenience of description, it is assumed that the first NE 10A be in the ACT state and the second NE 10B be in the STBY state.

The CPU 36 in the first NE 10A and the CPU 36 in the second NE 10B execute period determination processing for determining period information (step S11). The period information includes the first period information of the first NE 10A in the ACT state and the second period information of the second NE 10B in the STBY state. The first period information includes the MFH period B of the first high priority flow flowing from the L2SW 8A into the L2SW-side port 11 in the first NE 10A. The first period information includes the MFH period E of the fifth high priority flow and the MFH period F of the sixth high priority flow that flow from the third NE 20 into the MC-LAG-side port 12 in the first NE 10A. The second period information of the second NE 10B includes the MFH period A of the second high priority flow flowing from the L2SW 8B into the L2SW-side port 11 in the second NE 10B.

Note that the period determination processing includes period determination for determining the MFH periods E and F of the fifth and the sixth high priority flows that flow from the third NE 20 into the MC-LAG-side port 12 in the first NE 10A. Moreover, the period determination processing includes period determination for determining the MFH period B of the first high priority flow flowing from the first NE 10A in the ACT state into the third NE 20. Moreover, the period determination processing includes period determination for determining the MFH period A of the second high priority flow flowing from the second NE 10B in the STBY state into the third NE 20 via the IPL 13 and the first NE 10A.

After executing the period determination processing, the CPU 36 in the first NE 10A and the CPU 36 in the second NE 10B execute period information synchronization processing (step S12). The period information synchronization processing is processing for synchronizing the first period information of the first NE 10A in the ACT state with the second period information of the second NE 10B in the STBY state between the first NE 10A and the second NE 10B.

After executing the period information synchronization processing, the CPU 36 in the first NE 10A and the CPU 36 in the second NE 10B execute IPL period fixing processing (step S13). The IPL period fixing processing is processing for fixing the iTAS periods of the iTAS devices 15 arranged in the IPL output ports 13A and 13B, based on the first period information of the first NE 10A in the ACT state and the second period information of the second NE 10B in the STBY state. The IPL period fixing processing is processing for fixing the first iTAS period α of the iTAS device 15 provided in the IPL output port 13A in the first NE 10A and the second iTAS period β of the iTAS device 15 provided in the IPL output port 13B in the second NE 10B.

After executing the IPL period fixing processing, the CPU 36 in the first NE 10A and the CPU 36 in the second NE 10B execute IPL period information synchronization processing (step S14). The IPL period information synchronization processing is processing for synchronizing the first iTAS period α of the iTAS device 15 provided in the IPL output port 13A with the second iTAS period β of the iTAS device 15 provided in the IPL output port 13B between the first NE 10A and the second NE 10B.

After executing the IPL period information synchronization processing, the CPU 36 in the first NE 10A and the CPU 36 in the second NE 10B execute L2SW-side port period fixing processing (step S15). The L2SW-side port period fixing processing is processing for fixing the iTAS periods of the iTAS devices 15 arranged in the L2SW output port 11A and the L2SW output port 11B, based on the first iTAS period α and the second iTAS period 3.

After executing the L2SW-side port period fixing processing, the CPU 36 in the first NE 10A and the CPU 36 in the second NE 10B execute MC-LAG-side port period fixing processing (step S16). The MC-LAG-side port period fixing processing is processing for fixing the third iTAS periods θ of the iTAS devices 15 arranged in the MC-LAG output port 12A and the MC-LAG output port 12B, based on the first iTAS period α and the second iTAS period 3.

The first NE 10A in the ACT state holds the first iTAS period α of the iTAS device 15 arranged in the IPL output port 13A and the third iTAS period θ of the iTAS device 15 arranged in the MC-LAG output port 12A, in the RAM 35. Moreover, the first NE 10A in the ACT state holds the iTAS period β of the iTAS device 15 arranged in the L2SW output port 11A, in the RAM 35. Similarly, the second NE 10B in the STBY state also holds the iTAS period β of the iTAS device 15 arranged in the IPL output port 13B and the third iTAS period θ of the iTAS device 15 arranged in the MC-LAG output port 12B, in the RAM 35. The second NE 10B in the STBY state holds the first iTAS period α of the iTAS device 15 arranged in the L2SW output port 11B, in the RAM 35. Therefore, even in a case where the STBY state is switched to the ACT state, the second NE 10B sets the first iTAS periods α, θ, and β to the respective iTAS devices 15 arranged in the IPL output port 13B, the L2SW output port 11B, and the MC-LAG output port 12B. Then, the second NE 10B executes the closed TS determination phase and the stationary monitoring phase. As a result, even in a case where the STBY state of the NE 10 is switched to the ACT state, the output delay of the high priority flow can be prevented while the NE 10 continues communication.

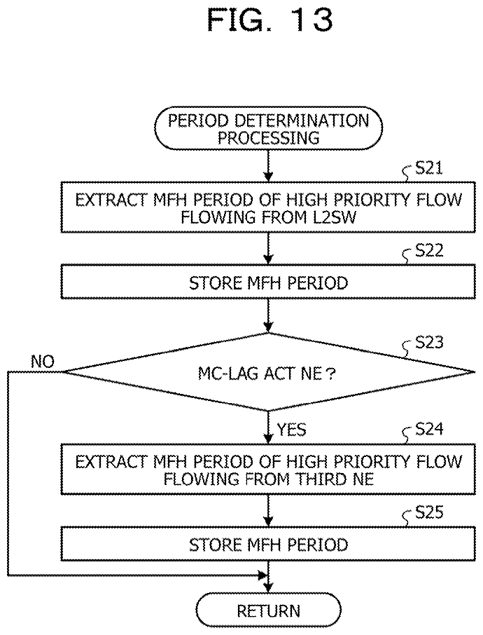

FIG. 13 is a flowchart illustrating an example of a processing operation of the first NE 10A and the second NE 10B related to the period determination processing. The first extraction unit 361A in the CPU 36 in the first NE 10A extracts each MFH period of the high priority flow flowing from the L2SW 8 (step S21). The first period management unit 362A in the CPU 36 in the first NE 10A stores the period information including the extracted MFH period B in each RAM 35 (step S22).

After storing the extracted MFH period in the RAM 35, the CPU 36 in the first NE 10A determines whether or not the own device is the NE 10 of the MC-LAG in the ACT state (step S23).

In a case where the own device is the NE 10 of the MC-LAG in the ACT state (step S23: Yes), the first extraction unit 361A extracts the MFH periods of the fifth and the sixth high priority flows flowing from the third NE 20 into the first NE 10A (step S24). Then, the first period management unit 362A stores first period information including the extracted MFH periods E and F in the RAM 35 (step S25) and ends the processing operation illustrated in FIG. 13. In a case where the own device is not the NE 10 of the MC-LAG in the ACT state (step S23: No), the CPU 36 in the first NE 10A ends the processing operation illustrated in FIG. 13. For example, the first NE 10A in the ACT state stores the first period information in the RAM 35.

The second extraction unit 361B in the second NE 10B extracts each MFH period of the high priority flow flowing from the L2SW 8 (step S21). The second period management unit 362B in the second NE 10B stores second period information including the extracted MFH period A in each RAM 35 (step S22). After storing the extracted MFH period in the RAM 35, the CPU 36 in the second NE 10B determines whether or not the own device is the NE 10 of the MC-LAG in the ACT state (step S23).

In a case where the own device is the NE 10 of the MC-LAG in the ACT state (step S23: Yes), the second extraction unit 361B extracts the MFH periods of the fifth and the sixth high priority flows flowing from the third NE 20 into the second NE 10B (step S24). Then, the second period management unit 362B stores second period information including the extracted MFH periods E and F in the RAM 35 (step S25) and ends the processing operation illustrated in FIG. 13. In a case where the own device is not the NE 10 of the MC-LAG in the ACT state, the CPU 36 in the second NE 10B ends the processing operation illustrated in FIG. 13.

Furthermore, since the CPU 36 in the second NE 10B determines that the own device is not the NE 10 of the MC-LAG in the ACT state, for example, the own device is the NE 10 in the STBY state (step S23: No), the CPU 36 ends the processing operation illustrated in FIG. 13. The second NE 10B in the STBY state stores the second period information in the RAM 35.

For example, the first NE 10A in the ACT state stores the first period information including the MFH period B of the first high priority flow, the MFH period E of the fourth high priority flow, and the MFH period F of the fifth high priority flow, in the RAM 35. Moreover, the second NE 10B in the STBY state stores the second period information including the MFH period A of the second high priority flow, in the RAM 35.

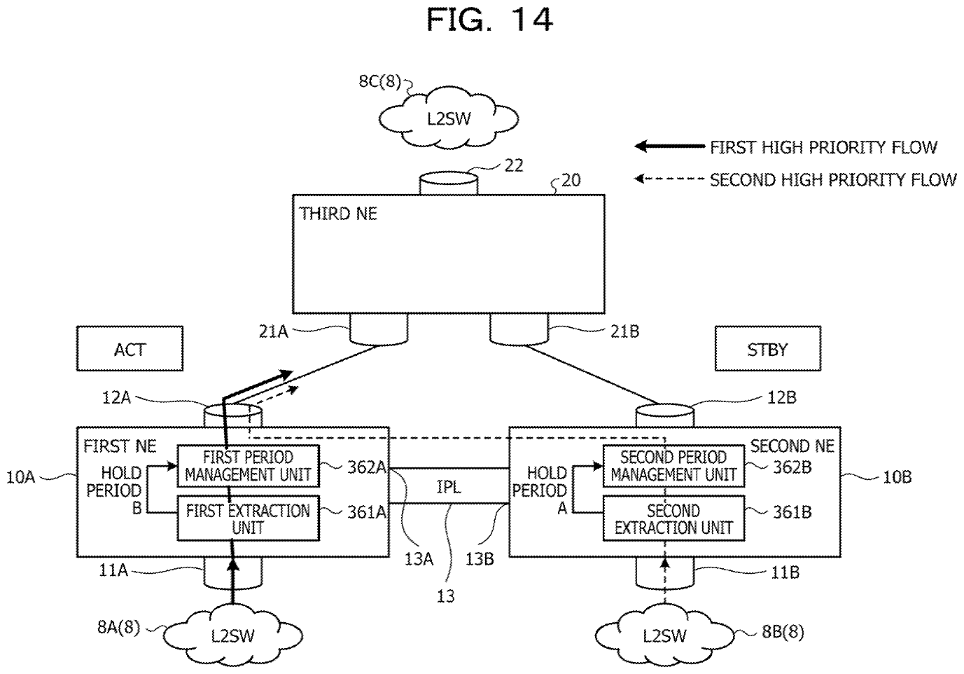

FIG. 14 is an explanatory diagram related to the processing for determining the period of the high priority flow flowing from the L2SW 8 by the first NE 10A and the second NE 10B. The first extraction unit 361A in the first NE 10A extracts the MFH period B of the first high priority flow flowing from the L2SW 8A. Then, the first period management unit 362A in the first NE 10A stores the extracted MFH period B in the RAM 35. Furthermore, the second extraction unit 361B in the second NE 10B extracts the MFH period A of the second high priority flow flowing from the L2SW 8B. The second period management unit 362B in the second NE 10B stores the extracted MFH period A in the RAM 35.

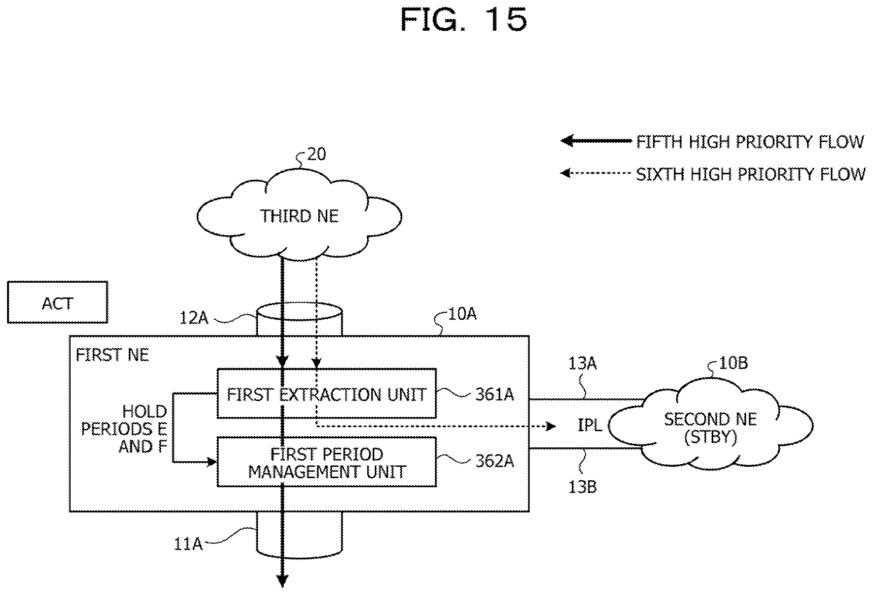

FIG. 15 is an explanatory diagram related to the processing for determining the period of the high priority flow flowing from the third NE 20, by the first NE 10A. Note that it is assumed that the first NE 10A be in the ACT state and the second NE 10B be in the STBY state. The first extraction unit 361A in the first NE 10A extracts the MFH period E of the fifth high priority flow and the MFH period F of the sixth high priority flow, flowing from the third NE 20. The first period management unit 362A in the first NE 10A stores the extracted MFH periods E and F in the RAM 35. Note that, since the second NE 10B is in the STBY state, it is assumed that the second NE 10B do not execute the processing for extracting the MFH period E of the fifth high priority flow and the MFH period F of the sixth high priority flow.

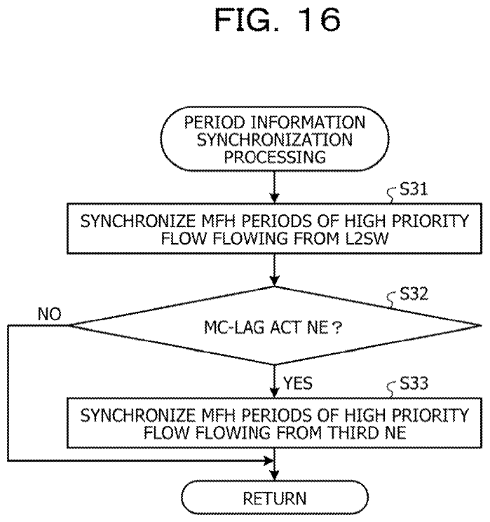

FIG. 16 is a flowchart illustrating an example of a processing operation of the first NE 10A and the second NE 10B related to the period information synchronization processing. The CPU 36 in the first NE 10A and the CPU 36 in the second NE 10B synchronize the MFH periods A and B of the high priority flow flowing from the L2SW 8 stored in the RAM 35, between the first NE 10A and the second NE 10B (step S31). For example, the MFH periods A and B having the same content are stored in the RAM 35 in the first NE 10A and the RAM 35 in the second NE 10B.

The CPU 36 in the first NE 10A and the CPU 36 in the second NE 10B determine whether or not the own device is the NE 10 of the MC-LAG in the ACT state (step S32).

In a case where the own device is the NE 10 of the MC-LAG in the ACT state (step S32: Yes), the CPU 36 in the first NE 10A synchronizes the MFH periods E and F stored in the RAM 35 with the first NE 10A (step S33). Note that the MFH periods E and F are the MFH period E of the fifth high priority flow and the MFH period F of the sixth high priority flow, flowing from the third NE 20. For example, the RAM 35 in the first NE 10A and the RAM 35 in the second NE 10B store the MFH periods A, B, E, and F.

Furthermore, since the CPU 36 in the second NE 10B determines that the own device is not the NE 10 of the MC-LAG in the ACT state, for example, the own device is the NE 10 in the STBY state (step S32: No), the CPU 36 ends the processing operation illustrated in FIG. 16.

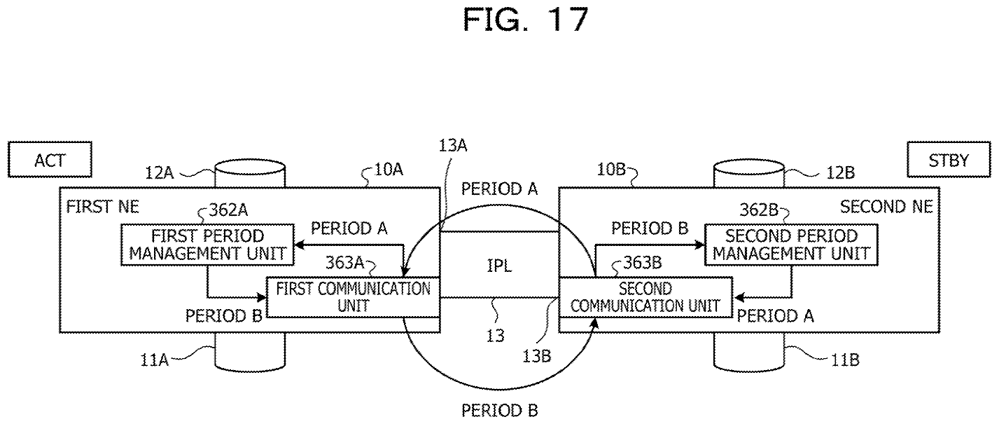

FIG. 17 is an explanatory diagram illustrating an example of a processing operation of the first NE 10A and the second NE 10B related to the period information synchronization processing when the MFH periods of the high priority flows flowing from the L2SWs 8 are synchronized. The first communication unit 363A in the first NE 10A notifies the second NE 10B of the MFH period B of the first high priority flow flowing from the L2SW 8A, via the IPL 13. The first period management unit 362A in the second NE 10B stores the MFH period B received from the first NE 10A, in the RAM 35. The second communication unit 363B in the second NE 10B notifies the first NE 10A of the MFH period A of the second high priority flow flowing from the L2SW 8B, via the IPL 13. The first period management unit 362A in the first NE 10A stores the MFH period A received from the second NE 10B, in the RAM 35. As a result, storage content of the RAM 35 in the first NE 10A and storage content of the RAM 35 in the second NE 10B (MFH periods A and B) are the same.

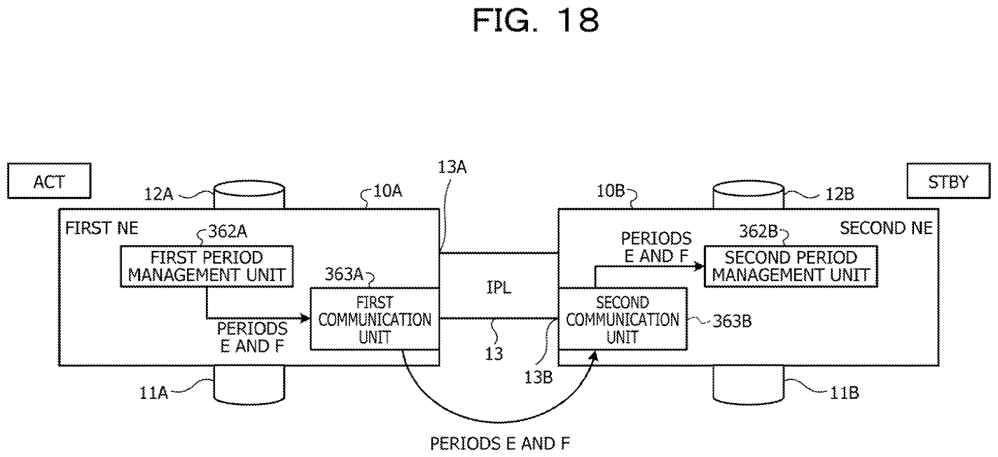

FIG. 18 is an explanatory diagram illustrating an example of a processing operation of the first NE 10A and the second NE 10B related to the period information synchronization processing when the MFH periods of the high priority flows flowing from the third NE 20 are synchronized. The first communication unit 363A in the first NE 10A notifies the second NE 10B of the MFH periods E and F of the high priority flows flowing from the third NE 20, via the IPL 13. In a case of receiving the MFH periods E and F from the first NE 10A, the second period management unit 362B in the second NE 10B stores the received MFH periods E and F in the RAM 35. As a result, storage content of the RAM 35 in the first NE 10A and storage content of the RAM 35 in the second NE 10B (MFH periods A, B, E, and F) are the same.

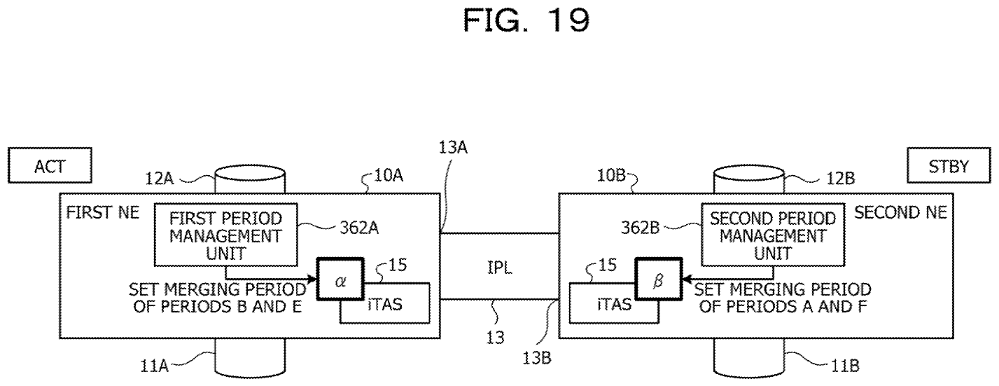

FIG. 19 is an explanatory diagram illustrating an example of a processing operation of the first NE 10A and the second NE 10B related to IPL-side port period fixing processing. The first period management unit 362A in the first NE 10A calculates the first iTAS period α in which the MFH period B and the MFH period E stored in the RAM 35 do not collide. Moreover, the first period management unit 362A stores the calculated first iTAS period α in the RAM 35. Note that the first iTAS period α is a period calculated based on the least common multiple of the MFH period B and the MFH period E, for example. Moreover, the first setting unit 362A2 in the first NE 10A sets the first iTAS period α stored in the RAM 35 to the GCL in the iTAS device 15 arranged in the IPL output port 13A. Note that, when the first iTAS period α of the iTAS device 15 arranged in the IPL output port 13A is calculated, the MFH period B and the MFH period E are used. This is because the high priority flows output from the IPL output port 13A are only the first high priority flow flowing from the L2SW 8A and the fifth high priority flow flowing from the third NE 20.

The second period management unit 362B in the second NE 10B calculates the second iTAS period β in which the MFH period A and the MFH period F stored in the RAM 35 do not collide. The second period management unit 362B stores the calculated second iTAS period β in the RAM 35. Note that the second iTAS period β is a period calculated based on the least common multiple of the MFH period A and the MFH period F, for example. Moreover, the second setting unit 362B2 in the second NE 10B sets the second iTAS period β stored in the RAM 35 to the GCL in the iTAS device 15 arranged in the IPL output port 13B. Note that, when the second iTAS period β set to the iTAS device 15 arranged in the IPL output port 13B is calculated, the MFH period A and the MFH period F are used. This is because the high priority flows output from the IPL output port 13B are only the second high priority flow flowing from the L2SW 8B and the sixth high priority flow flowing from the third NE 20.

For example, the first setting unit 362A2 in the first NE 10A sets the stored first iTAS period α to the GCL in the iTAS device 15 arranged in the IPL output port 13A. The second setting unit 362B2 in the second NE 10B sets the stored second iTAS period β to the GCL in the iTAS device 15 arranged in the IPL output port 13B. As a result, even in a case where the STBY state is switched to the ACT state, the iTAS periods of the iTAS devices 15 arranged in the IPL output ports 13A and 13B can be easily set.

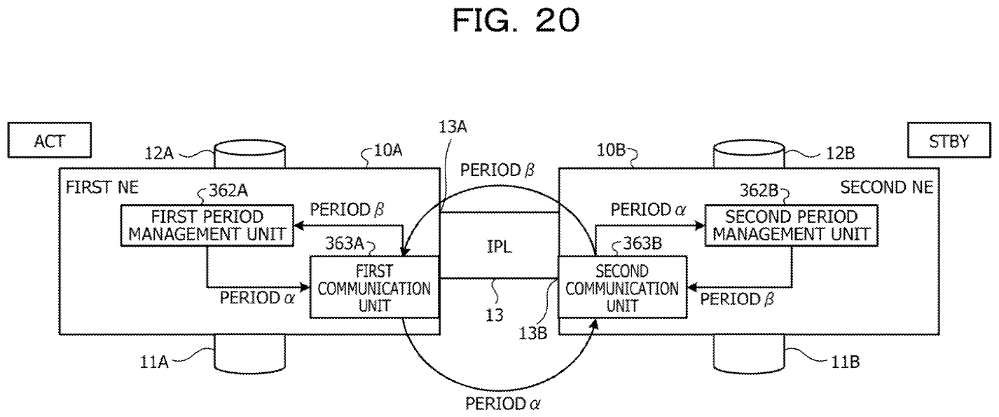

FIG. 20 is an explanatory diagram illustrating an example of a processing operation of the first NE 10A and the second NE 10B related to the IPL period information synchronization processing. The first communication unit 363A in the first NE 10A notifies the second NE 10B of the first iTAS period α of the iTAS device 15 arranged in the IPL output port 13A stored in the RAM 35, via the IPL 13. Moreover, in a case of receiving the first iTAS period α from the first NE 10A, the second period management unit 362B in the second NE 10B stores the received first iTAS period α in the RAM 35.

The second communication unit 363B in the second NE 10B notifies the first NE 10A of the second iTAS period β of the iTAS device 15 arranged in the IPL output port 13B stored in the RAM 35, via the IPL 13. Moreover, in a case of receiving the second iTAS period β from the second NE 10B, the first period management unit 362A in the first NE 10A stores the received second iTAS period β in the RAM 35.

As a result, the first period management unit 362A of the first NE 10A stores the first iTAS period α of the iTAS device 15 arranged in the IPL output port 13A and the second iTAS period β of the iTAS device 15 arranged in the IPL output port 13B. The second period management unit 362B of the second NE 10B stores the first iTAS period α of the iTAS device 15 arranged in the IPL output port 13A and the second iTAS period β of the iTAS device 15 arranged in the IPL output port 13B.

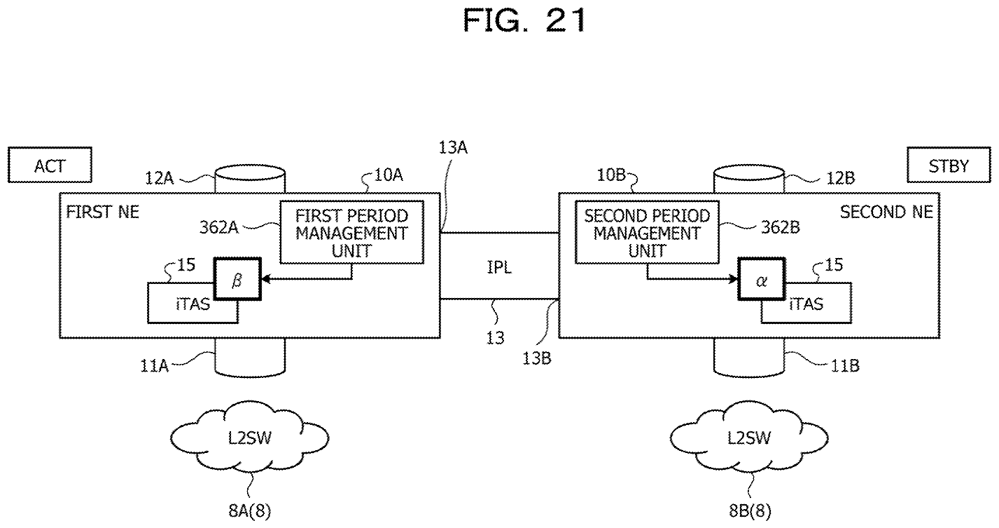

FIG. 21 is an explanatory diagram illustrating an example of a processing operation of the first NE 10A and the second NE 10B related to the L2SW-side port period fixing processing. The first setting unit 362A2 in the first NE 10A sets the second iTAS period β of the iTAS device 15 arranged in the IPL output port 13B in the second NE 10B stored in the RAM 35 as the iTAS period of the iTAS device 15 arranged in the L2SW output port 11A. Note that the reason why the second iTAS period β is set to the iTAS device 15 arranged in the L2SW output port 11A is because the high priority flow output from the L2SW output port 11A is the high priority flow flowing from the second NE 10B.

The second setting unit 362B2 in the second NE 10B sets the first iTAS period α of the iTAS device 15 arranged in the IPL output port 13A in the first NE 10A stored in the RAM 35 to the GCL of the iTAS device 15 arranged in the L2SW output port 11B. Note that the reason why the first iTAS period α is set to the iTAS device 15 arranged in the L2SW output port 11B is because the high priority flow output from the L2SW output port 11B is only the high priority flow flowing from the first NE 10A.

The first NE 10A sets the second iTAS period β of the iTAS device 15 arranged in the IPL output port 13B in the second NE 10B that is stored as the iTAS period of the iTAS device 15 arranged in the L2SW output port 11A. The second NE 10B sets the first iTAS period α of the iTAS device 15 arranged in the IPL output port 13A in the first NE 10A that is stored as the iTAS period of the iTAS device 15 arranged in the L2SW output port 11B. As a result, even in a case where the STBY state is switched to the ACT state, by greatly reducing a time required for learning the iTAS period, the iTAS periods of the iTAS devices 15 arranged in the L2SW output ports 11A and 11B can be easily set.

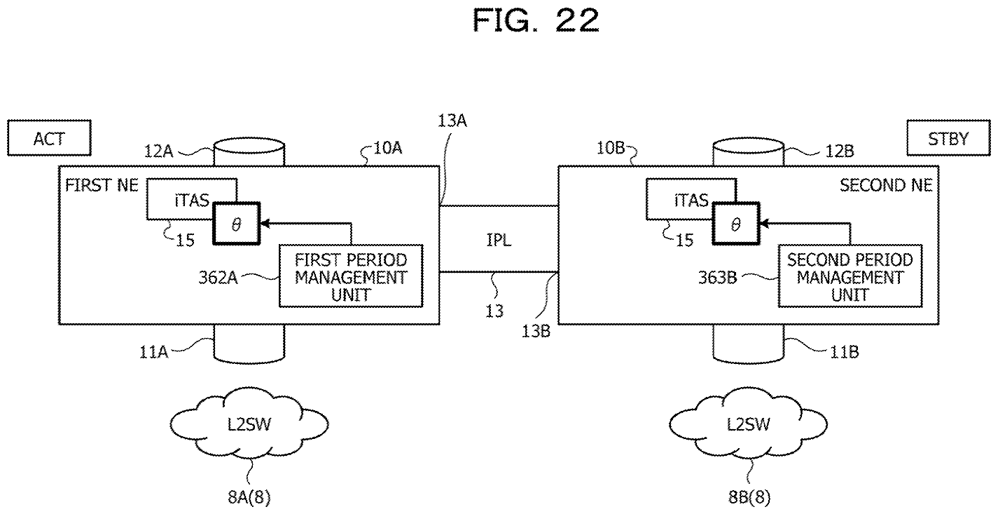

FIG. 22 is an explanatory diagram illustrating an example of a processing operation of the first NE 10A and the second NE 10B related to MC-LAG output port period fixing processing. The first period management unit 362A in the first NE 10A calculates the third iTAS period θ so that the iTAS periods α and β stored in the RAM 35 do not collide. The first setting unit 362A2 in the first NE 10A sets the third iTAS period θ to the iTAS period of the iTAS device 15 arranged in the MC-LAG output port 12A. Note that the reason why the third iTAS period θ is set to the iTAS device 15 arranged in the MC-LAG output port 12A is because the high priority flow output from the MC-LAG output port 12A is the high priority flow flowing from the second NE 10B and the L2SW 8A.

The second period management unit 362B in the second NE 10B calculates the third iTAS period θ so that the iTAS periods α and β stored in the RAM 35 do not collide. The second setting unit 362B2 in the second NE 10B sets the third iTAS period θ to the iTAS period of the iTAS device 15 arranged in the MC-LAG output port 12B. Note that the reason why the third iTAS period θ is set to the iTAS device 15 arranged in the MC-LAG output port 12B is because the high priority flow output from the MC-LAG output port 12B is the high priority flow flowing from the first NE 10A and the L2SW 8B.

The first setting unit 362A2 in the first NE 10A sets the third iTAS period θ to the iTAS period of the iTAS device 15 arranged in the MC-LAG output port 12A. The second setting unit 362B2 in the second NE 10B sets the third iTAS period θ to the iTAS period of the iTAS device 15 arranged in the MC-LAG output port 12B. As a result, even in a case where the STBY state is switched to the ACT state, by greatly reducing a time required for learning the iTAS period, the iTAS periods of the iTAS devices 15 arranged in the MC-LAG output ports 12A and 12B can be easily set.

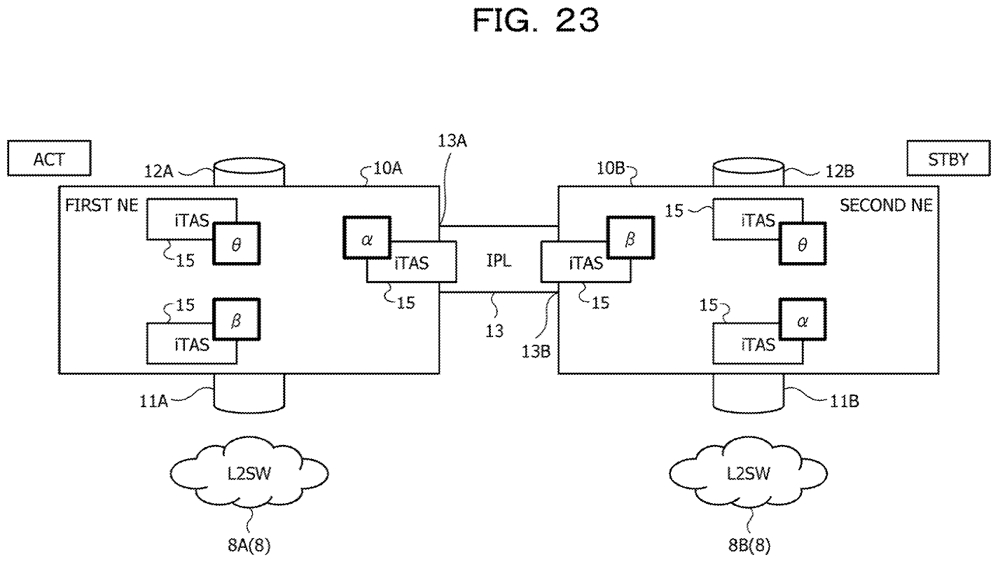

FIG. 23 is an explanatory diagram illustrating an example of a processing operation of the first NE 10A and the second NE 10B related to the stationary monitoring phase. When the second iTAS period β is set, the iTAS device 15 arranged in the L2SW output port 11A in the first NE 10A executes the closed TS determination phase after updating content of the GCL according to the second iTAS period 3. Then, the iTAS device 15 arranged in the L2SW output port 11A in the first NE 10A executes stationary monitoring processing, based on the content of the GCL after the execution of the closed TS determination phase.

Moreover, when the third iTAS period θ is set, the iTAS device 15 arranged in the MC-LAG output port 12A in the first NE 10A executes the closed TS determination phase after updating the content of the GCL according to the third iTAS period θ. Then, the iTAS device 15 arranged in the MC-LAG output port 12A in the first NE 10A executes the stationary monitoring processing, based on the content of the GCL after the execution of the closed TS determination phase.

Moreover, when the first iTAS period α is set, the iTAS device 15 arranged in the IPL output port 13A in the first NE 10A executes the closed TS determination phase after updating the content of the GCL according to the first iTAS period α. Then, the iTAS device 15 arranged in the IPL output port 13A in the first NE 10A executes the stationary monitoring processing, based on the content of the GCL after the execution of the closed TS determination phase.

When the first iTAS period α is set, the iTAS device 15 arranged in the L2SW output port 11B in the second NE 10B executes the closed TS determination phase after updating the content of the GCL according to the first iTAS period α. Then, the iTAS device 15 arranged in the L2SW output port 11B in the second NE 10B executes the stationary monitoring processing, based on the content of the GCL after the execution of the closed TS determination phase.

Moreover, when the third iTAS period θ is set, the iTAS device 15 arranged in the MC-LAG output port 12B in the second NE 10B executes the closed TS determination phase after updating the content of the GCL according to the third iTAS period θ. Then, the iTAS device 15 arranged in the MC-LAG output port 12B in the second NE 10B executes the stationary monitoring processing, based on the content of the GCL after the execution of the closed TS determination phase.

Moreover, when the second iTAS period β is set, the iTAS device 15 arranged in the IPL output port 13B in the second NE 10B executes the closed TS determination phase after updating the content of the GCL according to the second iTAS period 3. Then, the iTAS device 15 arranged in the IPL output port 13B in the second NE 10B executes the stationary monitoring processing, based on the content of the GCL after the execution of the closed TS determination phase.

For example, after executing the closed TS determination phase, each iTAS device 15 in the first NE 10A in the ACT state executes the stationary monitoring phase for autonomously learning the content of the GCL while executing priority output of the high priority flow. Since each iTAS device 15 in the second NE 10B in the STBY state stores the iTAS periods α, β, and θ, the iTAS periods α, β, and θ are set to each iTAS device 15 when the STBY state is switched to the ACT state. As a result, since the second NE 10B sets each iTAS period in each iTAS device 15 even if the STBY state is switched to the ACT state, the second NE 10B can prevent the output delay of the high priority flow while securing communication reliability.

The first NE 10A according to the present embodiment stores the first iTAS period α of the iTAS device 15 arranged in the IPL output port 13A and the first iTAS period α of the iTAS device 15 arranged in the IPL output port 13B. The first NE 10A sets the third iTAS period θ in which the first iTAS period α and the second iTAS period β do not collide, to the iTAS device 15 arranged in the MC-LAG output port 12A. Moreover, the first NE 10A sets the second iTAS period β to the iTAS device 15 arranged in the L2SW output port 11A. As a result, by greatly reducing the time required for learning the iTAS period, the first NE 10A can easily set the iTAS periods of the iTAS devices 15 arranged in the IPL output port 13A, the MC-LAG output port 12A, and the L2SW output port 11A.

The second NE 10B stores the first iTAS period α of the iTAS device 15 arranged in the IPL output port 13A and the first iTAS period α of the iTAS device 15 arranged in the IPL output port 13B. The second NE 10B sets the third iTAS period θ in which the first iTAS period α and the second iTAS period β do not collide, to the iTAS device 15 arranged in the MC-LAG output port 12B. Moreover, the second NE 10B sets the second iTAS period β to the iTAS device 15 arranged in the L2SW output port 11B. As a result, by greatly reducing the time required for learning the iTAS period, the second NE 10B can easily set the iTAS periods of the iTAS devices 15 arranged in the IPL output port 13B, the MC-LAG output port 12B, and the L2SW output port 11B.

In the present embodiment, by skipping a period determination phase that takes time for autonomous learning of the iTAS period and accelerating a transition to the closed TS determination phase and the stationary monitoring phase, it is possible to prevent the output delay of the high priority flow even at the time of MC-LAG switching. Moreover, since the iTAS device arranged in each output port does not individually perform learning and iTAS control can be performed through learning by the minimum number of ports that needs the period information, it is possible to efficiently realize iTAS learning at the time of MC-LAG configuration.

Note that a case has been described where the iTAS period fixing processing illustrated in FIG. 12 is executed at a predetermined periodic timing during operation. However, the iTAS period fixing processing may be executed at a timing where correction occurs in the GCL during autonomous learning and may be appropriately changed.

In the iTAS period fixing processing, a case has been described where the MC-LAG-side port period fixing processing is executed after the L2SW-side port period fixing processing has been executed. However, the L2SW-side port period fixing processing may be executed after the MC-LAG-side port period fixing processing has been executed, and may be appropriately changed.

In the iTAS period fixing processing, a case has been described where the period information synchronization processing is executed after the period determination processing has been executed according to the predetermined timing. However, after the period determination processing has been executed, the period information synchronization processing may be executed only in a case where the period information at the previous time is different from the period information at this time and may be appropriately changed.

Furthermore, it is described that each of the first NE 10A and the second NE 10B includes the three output ports including the L2SW output port 11A (11B), the MC-LAG output port 12A (12B), and the IPL output port 13A (13B). However, the number of ports is not limited to three, and as long as the number of output ports of the first NE 10A is the same as that of the second NE 10B, the number of output ports may be equal to or more than four and may be appropriately changed. While considering a path of the high priority flow flowing each port, the iTAS period of the iTAS device 15 arranged in another output port can be determined based on the iTAS period of the iTAS device 15 of the IPL output port 13A (13B).

Furthermore, each of the components of each of the units illustrated in the drawings does not necessarily have to be physically configured as illustrated in the drawings. For example, specific forms of separation and integration of each of the units are not limited to the illustrated forms, and all or some of the units may be configured by being functionally or physically separated and integrated in any unit according to various loads, use situations, or the like.

Moreover, all or any part of various processing functions executed in each of the devices may be executed by a central processing unit (CPU) (or a microcomputer such as a micro processing unit (MPU) or a micro controller unit (MCU)). Furthermore, all or some of the various processing functions may of course be executed by a program to be analyzed and executed by a CPU (or microcomputer such as MPU and MCU) or hardware using wired logic.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication device to be coupled to a transmission device with multi-chassis link aggregation (MC-LAG), the communication device comprising:
a first output port coupled to an other communication device, the first output port being included within a first route;
a second output port within a second route;
an intelligent time aware shaper (iTAS) device arranged in each of the first output port and the second output port, and configured to preferentially output a high priority flow, based on a set iTAS period;
a memory; and
a processor coupled to the memory and configured to:
acquire a first iTAS period set to the iTAS device arranged in the first output port and a second iTAS period set to an iTAS device arranged in a third output port in the other communication device, the third output port being included within the first route, and
set an iTAS period of the iTAS device arranged in the second output port based on the first iTAS period and the second iTAS period.

2. The communication device according to claim 1, further comprising:
a fourth output port coupled to a first path; and
a fifth output port coupled to the transmission device by using a second path, and
wherein the processor is configured to set a third iTAS period to the iTAS device arranged in the fifth output port, and set the second iTAS period to the iTAS device arranged in the fourth output port, and
wherein the third iTAS period is set so the first iTAS period and the second iTAS period do not collide.

3. The communication device according to claim 2, wherein the third iTAS period in which the first iTAS period and the second iTAS period do not collide is a least common multiple iTAS period of the first iTAS period and the second iTAS period.

4. A communication switch comprising:
a transmission device; and
two communication devices configured to be coupled to the transmission device with multi-chassis link aggregation (MC-LAG), the two communication devices including a first communication device and a second communication device, the first communication device including:
a first output port coupled to the second communication device, the first output port being included within a first route,
a second output port within a second route,
an intelligent time aware shaper (iTAS) device arranged in each of the first output port and the second output port, and configured to preferentially output a high priority flow, based on a set iTAS period,
a first memory, and
a first processor coupled to the first memory and configured to:
acquire a first iTAS period set to the iTAS device arranged in the first output port and a second iTAS period set to the iTAS device arranged in a third output port in the second communication device, the third output port included within the first route, and
set an iTAS period of the iTAS device arranged in the second output port, based on the first iTAS period and the second iTAS period.

5. The communication switch according to claim 4, further comprising:
a fourth output port coupled to the first path and a fifth output port coupled to the transmission device by using the second path, and
wherein the first processor is configured to set a third iTAS period to the iTAS device arranged in the fifth output port, and set the second iTAS period to the iTAS device arranged in the fourth output port, and
wherein the third iTAS period is set so the first iTAS period and the second iTAS period do not collide.

6. The communication switch according to claim 5,
wherein the second communication device includes:
a sixth output port coupled to a third path,
a seventh output port coupled to the transmission device by using the second path,
the third output port coupled to the first communication device via the first route,
iTAS devices of the second communication device arranged in each of the sixth output port, the seventh output port, and the third output port, and each of the iTAS devices configured to preferentially output the high priority flow, based on the set iTAS period,
a second memory, and
a second processor coupled to the second memory and configured to:
acquire the first iTAS period and the second iTAS period, and
set the third iTAS period to the iTAS device of the second communication device arranged in the seventh output port, and set the first iTAS period to the iTAS device of the second communication device arranged in the sixth output port.

7. The communication switch according to claim 6,
wherein the first processor is further configured to:
extract a first period of a first high priority flow that flows from the first path, a second period of a second high priority flow that flows from the second path into the first path, and a third period of a third high priority flow that flows from the second path into the first route via the first communication device in a case where an MC-LAG is in an active state, and
notify the second communication device via the first route, of the first period, the second period, and the third period, and
wherein the second processor is further configured to:
extract a fourth period of a fourth high priority flow that flows from the third path, in a case where the MC-LAG is in a standby state, and
notify the first communication device of the fourth period via the first route, and receive the first period, the second period, and the third period from the first communication device.

8. The communication switch according to claim 7,
wherein the first processor is configured to:
acquire the first iTAS period that is a period in which the first period and the third period do not collide, based on the first period and the third period,
notify the second communication device of the first iTAS period,
acquire the second iTAS period that is a period in which the second period and the fourth period do not collide, based on the second period and the fourth period, and
notify the first communication device of the second iTAS period.

9. An intelligent time aware shaper (iTAS) period setting method of a communication device to be coupled to a transmission device with multi-chassis link aggregation (MC-LAG), the communication device including a first output port coupled to an other communication device, the first output port being included with a first route, a second output port within a second route, an intelligent time aware shaper (iTAS) device arranged in each of the first output port and the second output port and configured to preferentially output a high priority flow, based on a set iTAS period, the iTAS period setting method comprising:
acquiring a first iTAS period set to the iTAS device arranged in the first output port and a second iTAS period set to an iTAS device arranged in a third output port in the other communication device, the third output port being included within the first route, and
setting an iTAS period of the iTAS device arranged in the second output port, based on the first iTAS period and the second iTAS period, by a processor.

10. The iTAS period setting method according to claim 9,
wherein the second output port includes a fourth output port coupled to a first path and a fifth output port coupled to the transmission device by using a second path, and
wherein the processor is configured to set a third iTAS period in which the first iTAS period and the second iTAS period do not collide to the iTAS device arranged in the fifth output port, and set the second iTAS period to the iTAS device arranged in the fourth output port.

11. The communication device according to claim 1, wherein the high priority flow is output without delay in a case where the first path is switched from an active state to a standby state and the second path is switched to the active state.
